(19) United States
(12) Patent Application Publication
(10) Pub. No.: US 2026/0121293 A1
(43) Pub. Date: Apr. 30, 2026

(54) PHASE-CONTROL ARRAY ANTENNA MODULE CAPABLE OF SUPRESSING GRATING LOBE GAIN AND PHASE-SHIFT CONTROL METHOD THEREOF

(71) Applicant: Cyntec Co., Ltd., Hsinchu (TW)

(72) Inventors: Chi-Ho Chang, Hsinchu (TW); Ping-Chang Huang, Hsinchu (TW); Sheng-Ju Chou, Hsinchu (TW); Chun-Chih Hou, Hsinchu (TW); Tsu Chang, Hsinchu (TW)

(21) Appl. No.: 19/367,607

(22) Filed: Oct. 23, 2025

Related U.S. Application Data
(60) Provisional application No. 63/713,060, filed on Oct. 29, 2024.

(51) Int. Cl. H01Q 3/36; H01Q 1/52

(52) U.S. Cl. CPC H01Q 3/36; H01Q 1/521

(57) ABSTRACT

A phase-control array antenna module capable of suppressing grating lobe gain is provided and includes an array antenna and a beam steering unit. The array antenna includes a plurality of sub-antennas, each of which includes at least one antenna unit. Any two adjacent sub-antenna rows or columns are staggered in the first direction. A phase-shift unit angle is formed between any two adjacent RF signals in the azimuth direction and changes in related to a steering angle of beam according to a microwave radiation field pattern of the array antenna in the azimuth direction. A compensation angle is formed between any two RF signals in an elevation direction from the two adjacent sub-antennas with and without staggering. In the first-phase shift unit angle interval, the compensation angle is a first compensation angle, and in the second phase-shift unit angle interval, the compensation angle is a second compensation angle.

### CROSS-REFERENCE TO RELATED APPLICATIONS

This application claims the benefit of U.S. Provisional Application No. 63/713,060 filed on Oct. 29, 2024, and entitled “ANTENNA ARRAY ARRANGEMENT AND PHASE SHIFT CONTROL METHOD TO EXPAND THE BEAM STEERING RANGE”, the entirety of which is incorporated herein by reference for all purposes.

### FIELD OF THE INVENTION

The present disclosure relates to a technical field of a phase-control array antenna module, and more particularly to a phase-control array antenna module capable of suppressing grating lobe gain and phase-shift control method thereof.

### BACKGROUND OF THE INVENTION

Phase-control array antenna modules have been widely used in various application scenarios such as the 5G mm wave frequency band (FR2) and low-orbit satellite communication. By utilizing large-scale array antennas and beamforming techniques, wireless signal communication and transmission with wider bandwidth and farther covering range can be achieved. However, phase-control array antenna modules usually face issues such as grating lobe gain affecting array antenna characteristics and limited beam steering angle range.

For solving the aforementioned issues, current techniques mainly make distance changes between two adjacent antenna units of an array antenna to suppress the grating lobe gain of array antenna. Although the aforementioned method can effectively suppress the influence of grating lobe gain, changing the distance between antenna units will change the beam steering range of the array antenna at the original frequency. Especially, in applications with a wider bandwidth, the issues of excessive grating lobes may sometimes be shifted to another frequency range. Therefore, the aforementioned method is not an efficient solution. There are other existing techniques such as adding coupling lines, parasitic patches, and metamaterials etc., in the array antennas to address the issues of excessive grating lobe gain. However, the aforementioned approaches will also affect the microwave radiation field pattern distribution of the array antennas at small steering angles (θ) and boresight. In addition, the complexity of design and production will increase enormously, resulting in great difficulties to maintain the distance between the antenna units of the array antenna at half the wavelength of air to avoid the side lobes and interference.

In other existing techniques of suppressing grating lobe gain, the grating lobes on both sides of the main beam are suppressed when the beam is directed toward the boresight. In some array antennas, an array antenna may include a plurality of sub-arrays, and the distance between the sub-arrays may be greater than half the wavelength of air, even up to one or 1.5 times the wavelength of air. When a complete array antenna is constructed, since the sub-arrays' spacing is greater than half the wavelength of air, as shown in FIG. 1, grating lobes are generated and amplified on both sides of the main beam. Consequently, the suppressing of grating lobe gains cannot be effectively achieved.

In addition, when the distance between any two adjacent sub-antenna rows (columns) of a traditional array antenna equals to half the wavelength of air, and the main beam steering (θ) is performed, as shown in FIGS. 2A, 2B and 2C, the gain of the grating lobe will increase gradually as the main beam steers to large angles on both sides. When the phase-shift unit angle (ψ) of the main beam (also called as the linear phase-shift unit) increases from 0° to 180°, the corresponding steering angle of the main beam is from 0° to 90° and the grating lobe is also shifted from −90° to 0°. At the end, when the phase-shift unit angle (ψ) of the main beam increases to 180° (ψ), the main beam is replaced by the grating lobe. Under this circumstance, the grating lobe swaps with the main beam, and the main beam becomes the grating lobe. Specifically, as shown in FIG. 2A, when the steering angle (θ) of the main beam is from 0° to 30°, the grating lobe gain is extremely low at −90°. As shown in FIG. 2B, when the steering angle (θ) of the main beam is between 45° to 50°, the grating lobe gain increase accordingly between) 310° (−50° and) 315° (−45°. As shown in FIG. 2C, when the steering angle (θ) of the main beam turns to 85°, the grating lobe enters within) 330° (−30° and the grating lobe gain increases. Meanwhile, the main beam and the grating lobe are exchanged with each other. Obviously, when a large beam steering angle of the traditional array antenna is performed, the energy difference (or gain difference) between the main beam and the grating lobe will drop below 10 dB, resulting in reduced efficiency of the array antenna. Thus, the issues of the grating lobe gain suppression have to be addressed.

Therefore, there is a need to provide a phase-control array antenna module and a phase-control method thereof in order to overcome the drawbacks of the conventional technologies.

### SUMMARY OF THE INVENTION

It is an object of the present disclosure to provide a phase-control array antenna module and a phase-shift control method thereof, which can achieve the effects of suppressing or eliminating the grating lobe gains of the array antenna, expanding the maximum steering angle range of the beam, and extending the dynamic range at large steering angles. When the beam generated by the array antenna is steered at its maximum steering angle, the performance of the array antenna will be influenced by the grating lobe (i.e., the side beam) gains and the attenuation of the main beam. By using the antenna array configuration of the phase-control array antenna module and the phase-shift control method of the present disclosure, the grating lobe gain is suppressed. Consequently, the stability, efficiency and performance of the beam generated by the array antenna are maintained when steering at large steering angles, and the maximum angle range of the beam steering and the dynamic range at large steering angles are expanded.

In accordance with an aspect of the present disclosure, a phase-control array antenna module is provided. The phase-control array antenna module includes an array antenna and a beam steering unit. The array antenna includes a plurality of sub-antennas arranged in an array to configure the aforementioned array antenna. Each sub-antenna includes at least one antenna unit. Any two adjacent sub-antenna rows or columns of the plurality sub-antennas are staggered in the first direction. The beam steering unit is configured to output or receive a plurality of RF signals via corresponding sub-antennas among the plurality of sub-antennas of the array antenna. A phase-shift unit angle is formed between any two of the RF signals in an Azimuth direction, wherein the phase-shift unit angle changes related to a steering angle of a beam according to a microwave radiation field pattern of the array antenna in the Azimuth direction. A compensation angle is formed between any two corresponding RF signals from two adjacent sub-antennas with and without staggering in an elevation direction. A first phase-shift unit angle interval of the phase-shift unit angle is corresponding to a first steering angle interval of the steering angle. A second phase-shift unit angle interval is corresponding to a second steering angle interval of the steering angle. Within the first phase-shift unit angle interval, the compensation angle is a first compensation angle; and within the second phase-shift unit angle interval, the compensation angle is a second compensation angle.

In accordance with another aspect of the present disclosure, a phase-shift control method of a phase-control array antenna module is provided. The phase-control array antenna module includes an array antenna and a beam steering unit. The array antenna includes a plurality of sub-antennas arranged in an array. Each sub-antenna includes at least one antenna unit. Any two adjacent sub-antenna rows or columns of the plurality of sub-antennas are staggered in the first direction. The beam steering unit is configured to output or receive a plurality of RF signals via corresponding sub-antennas among the plurality of sub-antennas of the array antenna. The phase-shift control method includes the following steps. In step S1, the beam steering unit outputs or receives a plurality of RF signals, wherein a phase-shift unit angle is formed between any two RF signals in an Azimuth direction, and the phase-shift unit angle changes related to a steering angle of a beam according to a microwave radiation field pattern of the array antenna in the Azimuth direction. In step S2, a compensation angle is formed between any two corresponding RF signals from two adjacent sub-antennas with and without staggering in an elevation direction, a first phase-shift unit angle interval of the phase-shift unit angle is corresponding to a first steering angle interval of the steering angle, and a second phase-shift unit angle interval of the phase-shift unit angle is corresponding to a second steering angle interval of the steering angle. In step S3, within the first phase-shift unit angle interval, the compensation angle is a first compensation angle; and within the second phase-shift unit angle interval, the compensation angle is a second compensation angle.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic diagram illustrating an exemplary microwave radiation field pattern of a traditional array antenna;

FIGS. 2A, 2B and 2C are schematic diagrams demonstrating the microwave radiation field patterns of a traditional array antenna steering at different steering angles;

FIG. 3 is a schematic perspective view illustrating a phase-control array antenna module according to an embodiment of the present disclosure;

FIG. 4 is a schematic perspective view illustrating a first exemplary array antenna of the phase-control array antenna module of FIG. 3;

FIGS. 5A and 5B are schematic diagrams illustrating the coordinates of the azimuth angle and elevation angle of the array antenna of FIG. 4;

FIG. 6 is a schematic diagram illustrating the steering angle intervals of the array antenna of FIG. 4;

FIG. 7A is a schematic perspective view illustrating a second exemplary array antenna of the phase-control array antenna module of FIG. 3;

FIG. 7B is a schematic perspective view illustrating a third exemplary array antenna of the phase-control array antenna module of FIG. 3;

FIG. 8 is a schematic perspective view illustrating portion of the array antenna of FIG. 4;

FIGS. 9A and 9B are front and rear perspective views of the first exemplary array antenna of FIG. 4, wherein the array antenna is an 8×8 array antenna;

FIG. 10A shows the phase-shift steering control table of the array antenna of FIG. 9A, wherein the linear phase-shift unit (ψ) is 150°;

FIG. 10B shows a microwave radiation field pattern of the array antenna, which performs the phase-shift control according to the phase-shift steering control table of FIG. 10A;

FIG. 11A shows the phase-shift steering control table of the array antenna of FIG. 9A, wherein the linear phase-shift unit (ψ) is 160°;

FIG. 11B shows a microwave radiation field pattern of the array antenna, which performs the phase-shift control according to the phase-shift steering control table of FIG. 11A;

FIG. 12A shows the phase-shift steering control table of the array antenna of FIG. 9A, wherein the linear phase-shift unit (ψ) is 180°;

FIG. 12B shows a microwave radiation field pattern of the array antenna, which performs the phase-shift control according to the phase-shift steering control table of FIG. 12A;

FIG. 13A shows the phase-shift steering control table of the array antenna of FIG. 9A, wherein the phase-shift steering control table is performed with an amplitude weighting adjustment;

FIG. 13B shows a microwave radiation field pattern of the array antenna, which performs the phase-shift control according to the phase-shift steering control table of FIG. 13A;

FIGS. 14A and 14B are front and rear perspective views of the second exemplary array antenna of FIG. 7A, wherein the array antenna is an 4×8 array antenna;

FIG. 15A shows the phase-shift steering control table of the array antenna of FIG. 14A, wherein the linear phase-shift unit (ψ) is 140°;

FIG. 15B shows a microwave radiation field pattern of the array antenna, which performs the phase-shift control according to the phase-shift steering control table of FIG. 15A;

FIG. 16A shows the phase-shift steering control table of the array antenna of FIG. 14A, wherein the linear phase-shift unit (ψ) is 180°;

FIG. 16B shows a microwave radiation field pattern of the array antenna, which performs the phase-shift control according to the phase-shift steering control table of FIG. 16A;

FIG. 17A shows the phase-shift steering control table of the array antenna of FIG. 14A, wherein the phase-shift steering control table is performed with an amplitude weighting adjustment;

FIG. 17B shows a microwave radiation field pattern of the array antenna, which performs the phase-shift control according to the phase-shift steering control table of FIG. 17A;

FIGS. 18A and 18B are front and rear perspective views of the third exemplary array antenna of FIG. 7B, wherein the array antenna is an 8×8 array antenna;

FIG. 19A shows the phase-shift steering control table of the array antenna of FIG. 18A, wherein the linear phase-shift unit (ψ) is 120°;

FIG. 19B shows a microwave radiation field pattern of the array antenna, which performs the phase-shift control according to the phase-shift steering control table of FIG. 19A;

FIG. 20A shows the phase-shift steering control table of the array antenna of FIG. 18A, wherein the linear phase-shift unit (ψ) is 150°;

FIG. 20B shows a microwave radiation field pattern of the array antenna, which performs the phase-shift control according to the phase-shift steering control table of FIG. 20A;

FIG. 21A shows the phase-shift steering control table of the array antenna of FIG. 18A, wherein the linear phase-shift unit (ψ) is 120°;

FIG. 21B shows a microwave radiation field pattern of the array antenna, which performs the phase-shift control according to the phase-shift steering control table of FIG. 21A;

FIG. 22A shows the phase-shift steering control table of the array antenna of FIG. 18A, wherein the linear phase-shift unit (ψ) is 150°;

FIG. 22B shows a microwave radiation field pattern of the array antenna, which performs the phase-shift control according to the phase-shift steering control table of FIG. 22A;

FIG. 23 is a flowchart illustrating the control method of the phase-control array antenna module of the present disclosure;

FIG. 24 is a flowchart illustrating the design of the phase-control array antenna module of the present disclosure for performing phase-shift compensation between two adjacent sub-antenna rows (columns);

FIG. 25A is a three-dimensional diagram illustrating an exemplary array antenna of the phase-control array antenna module of the present disclosure;

FIGS. 25B, 25C and 25D are top, front and side perspective views illustrating the array antenna of FIG. 25, respectively;

FIGS. 26A and 26B show three-dimensional radiation field pattern of the array antenna and two-dimensional radiation field pattern corresponding to each Phi angle shown in FIG. 25A;

FIG. 26C shows the reflection coefficient of the array antenna of FIG. 25A; and

FIG. 26D is a schematic perspective view illustrating the cross-polarization isolation of the dual-polarization array antenna shown in FIG. 25A.

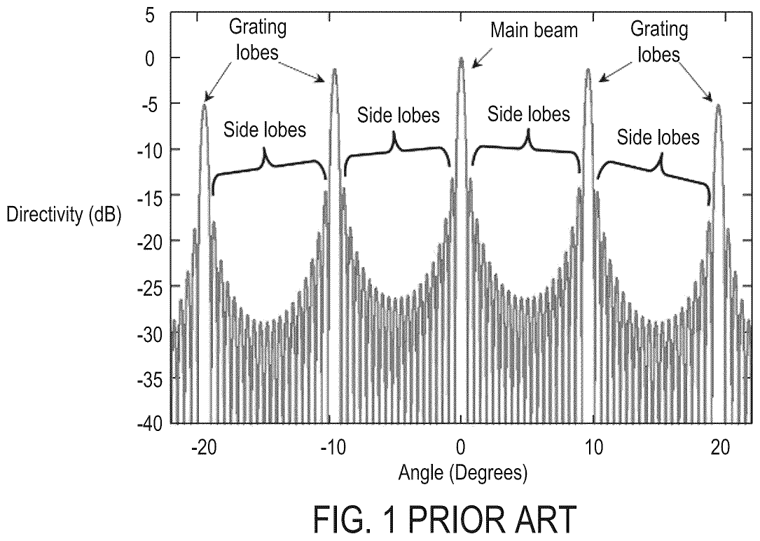

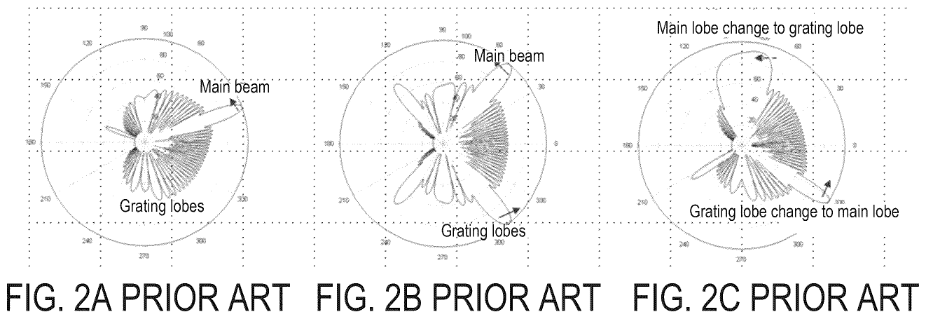

### DETAILED DESCRIPTION OF THE PREFERRED EMBODIMENT

The present disclosure will now be described more specifically with reference to the following embodiments. It is noted that the following descriptions of the preferred embodiments of the present disclosure are presented herein for purpose of illustration and description only. It is not intended to be exhaustive or to be limited to the precise from disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed. Further, spatially relative terms, such as “top,” “bottom,” “upper,” “lower” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items.

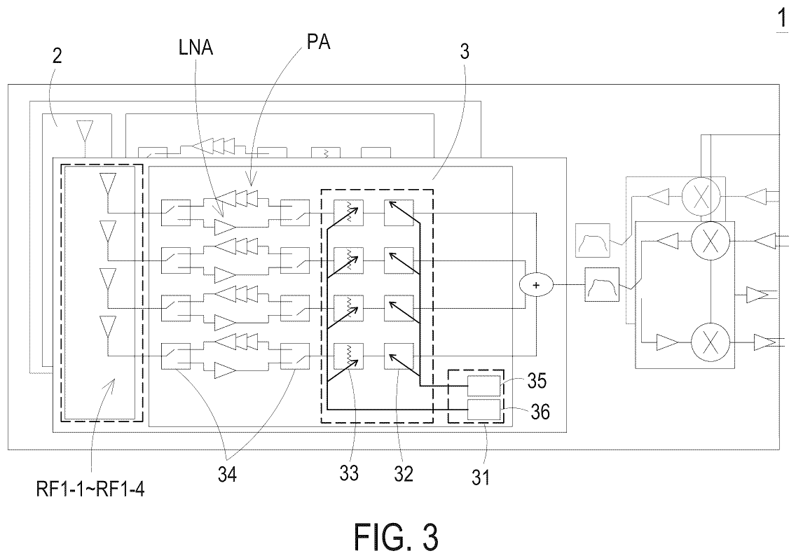

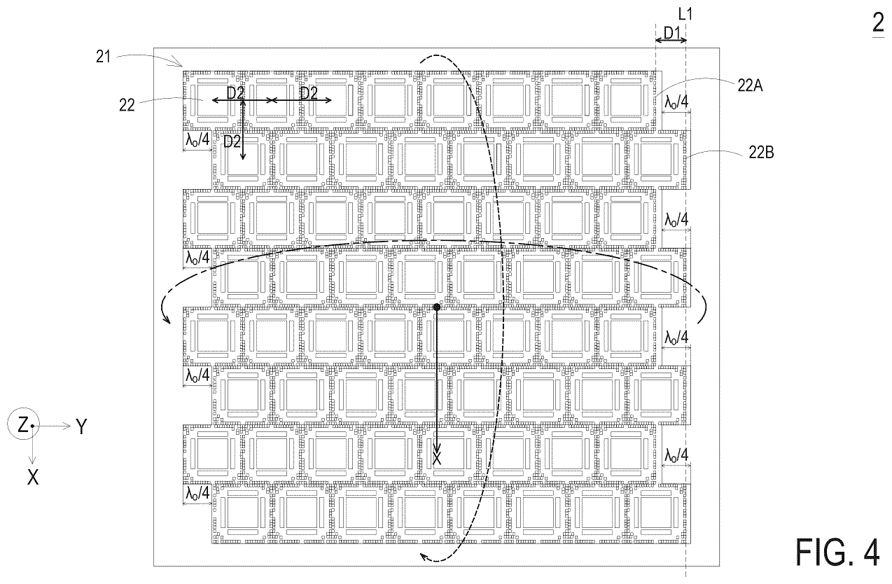

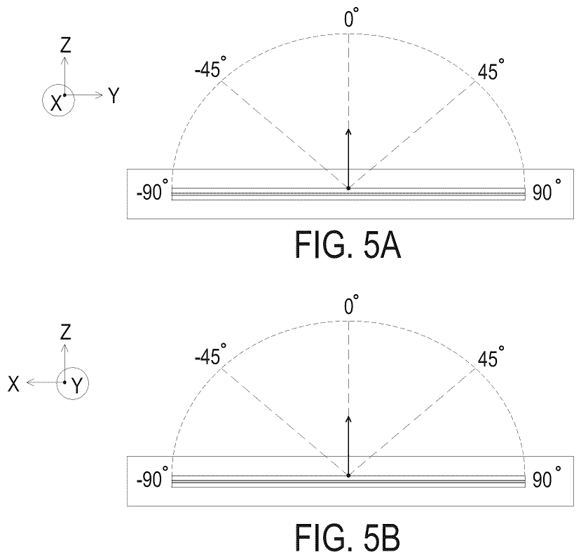

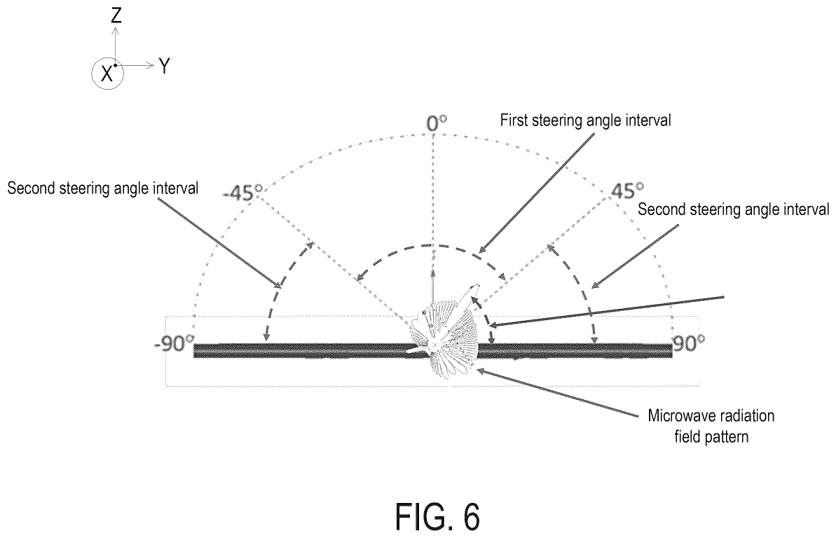

FIG. 3 is a schematic perspective view illustrating a phase-control array antenna module according to an embodiment of the present disclosure. FIG. 4 is a schematic perspective view illustrating a first exemplary array antenna of the phase-control array antenna module of FIG. 3. FIGS. 5A and 5B are schematic diagrams illustrating the coordinates of the azimuth angle and elevation angle of the array antenna of FIG. 4. FIG. 6 is a schematic diagram illustrating the steering angle intervals of the array antenna of FIG. 4. As shown in FIGS. 3 and 4, the phase-control array antenna module 1 of the present disclosure includes an array antenna 2 and a beam steering unit 3. The array antenna 2 includes a plurality of sub-antennas 21, and the plurality of sub-antennas 21 are arranged in an array to form the array antenna 2. Each sub-antenna 21 includes at least one antenna unit 22, and any two adjacent sub-antenna rows or columns of the plurality of sub-antennas 21 are staggered in a first direction (i.e., the X-axis direction). The beam steering unit 3 is configured to output or receive a plurality of RF signals from corresponding sub-antennas 21 among the plurality of sub-antennas 21 of array antenna 2.

In some embodiments, as shown in FIG. 4, the plurality of sub-antennas 21 of the array antenna 2 are configured to form a plurality of sub-antenna rows or a plurality of sub-antenna columns (hereinafter referred to sub-antenna row (column)), wherein any two adjacent sub-antenna rows (columns) are staggered in the first direction (i.e., the X-axis direction), and an staggered space D1 is formed between any two adjacent sub-antenna rows (columns) and is one quarter wavelength (e.g., one quarter wavelength of air). In some embodiments, preferably but not exclusively, the length of the staggered spacing D1 is in the range between 2.36 mm and 2.93 mm, and a spacing D2 is formed between any two adjacent antenna units 22, and the length of the spacing D2 is in the range between 5.26 mm and 5.66 mm, but not limited thereto. In some embodiments, the outer ends 22A of the antenna units 22 at the ends of the odd-numbered rows (columns) among the plurality of sub-antenna rows (columns) are aligned with each other and have the aforementioned staggered spacing D1 with respect to a reference line L1. The outer ends 22B of the antenna units 22 at the ends of the even-numbered rows (columns) among the plurality of sub-antenna rows (columns) are aligned with each other and aligned with the reference line L1. In other embodiments, the outer ends 22A of the antenna units 22 at the ends of the odd-numbered rows (columns) among the plurality of sub-antenna rows (columns) are aligned with each other and are located on the reference line L1. The outer ends 22B of the antenna units 22 at the ends of the even-numbered rows (columns) among the plurality of sub-antenna rows (columns) are aligned with each other and have the staggered spacing D1 with respect to the reference line L1.

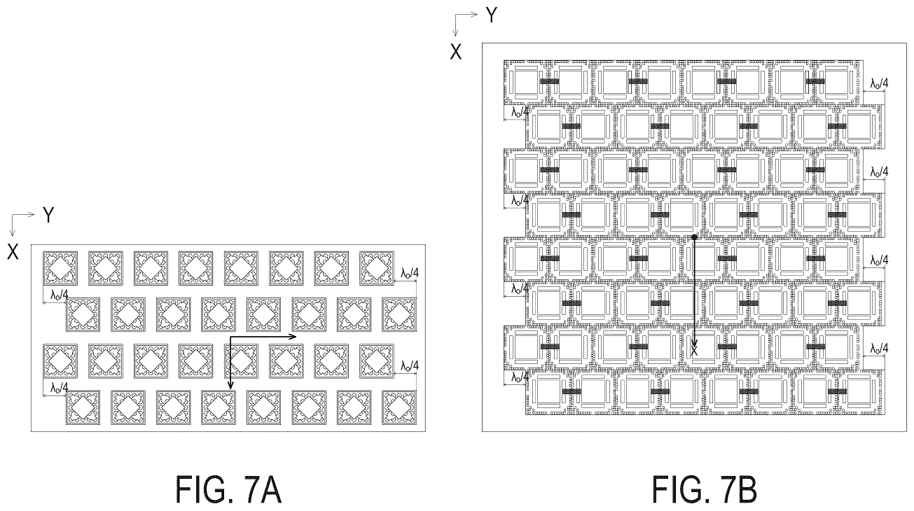

In some embodiments, the number of sub-antenna columns in the first direction (i.e., the X-axis direction) is equal to the number of sub-antenna columns in the second direction (i.e., the Y-axis direction), wherein the first direction and the second direction are orthogonal to each other on one surface of the array antenna 2. Alternatively, in other embodiments, the number of sub-antenna columns in the first direction is less than the number of sub-antenna columns in the second direction. It should be emphasized that array antenna 2 of the aforementioned embodiments uses 8×8 array antenna 2 as examples (as shown in FIG. 4). The number of sub-antenna columns (rows) of the array antenna 2 is not limited to the aforementioned embodiments, and can be varied according to the practical requirements. For example, in some embodiments, as shown in FIG. 7A, the array antenna 2 is a 4×8 (or 8×4) array antenna. In some other embodiments, as shown in FIG. 7B, the array antenna 2 is an array antenna formed by splicing (connecting) two adjacent sub-antennas in the azimuth direction based on an 8×8, 8×4, or 4×8 array antenna. For example, two antenna units 22 of the sub-antenna row are arranged in the second direction, and the corresponding feeding ends of the two antenna units 22 are electrically connected in parallel, wherein the number of sub-antenna columns in the first direction is greater than the number of sub-antenna columns in the second direction.

Please refer to FIGS. 4, 5A, 5B and 6. In this embodiment, the array antenna 2 includes azimuth angle (i.e., Azimuth, AZ) and elevation angle (i.e., Elevation, EL). The azimuth angle (Az) and the elevation angle (EL) are two main angle elements of the beam direction corresponding to the RF signals generated by the array antenna 2. As shown in FIGS. 4 and 5A, the azimuth angle is defined as the angle measured from a reference direction (i.e., the Y-axis direction) to the beam direction on a horizontal plane (i.e., the XY plane), which is used to determine the steering of the beam in the YZ plane. As shown in FIGS. 4 and 5B, the elevation angle is defined as the elevation angle of the beam measured from the horizontal plane (i.e., XY plane), which is used to determine the steering of the beam in the XZ plane. If the beam is transmitted straight up (i.e., Z-axis direction), the elevation angle is 0°. If the beam is transmitted horizontally on the XZ plane, the elevation angle is (+) 90°. The phase-control array antenna module 1 of the present disclosure can be controlled by performing phase-shift to adjust the Az and EL angles of the beam dynamically. Consequently, the beam scanning and pointing to specific direction without actually rotating the array antenna 2 can be performed.

In this embodiment, a phase-shift unit angle (or linear phase-shift unit (Δψ-y) (Δψ-Az) is formed between any two aforementioned RF signals in azimuth direction (i.e., Y (Az) direction) of the array antenna 2. The aforementioned phase-shift unit angle changes related to a steering angle of beam corresponding to one microwave radiation field pattern of the array antenna 2 in azimuth direction. In other words, the phase-shift unit angle of the RF signal is related to a steering angle (θ-y, θ-Az) (or pointing angle) of a beam and the correlation between the phase-shift unit angle of RF signal and a beam steering angle of the array antenna 2 changes with the characteristics of the array antenna.

In this embodiment, the array antenna 2 of the phase-control array antenna module 1 of the present disclosure includes two adjacent sub-antenna rows (columns) with staggered arrangement. A compensation angle (i.e., leading or lagging a specific phase angle) is defined or formed between any two corresponding RF signals in an elevation direction (i.e., the X-axis (EL) direction) from the RF signals of the sub-antenna 21 in the non-staggered sub-antenna row (column) and the RF signals of the sub-antenna 21 in the staggered sub-antenna row (column). The phase-shift unit angle includes a first phase-shift unit angle interval and a second phase-shift unit angle interval. The steering angle of the beam of the array antenna 2 includes a first steering angle interval and a second steering angle interval. In one embodiment, the first steering angle interval is a small-angle steering interval, and the second steering angle interval is a large-angle steering interval, but it is not limited thereto. The first phase-shift unit angle interval of the phase-shift unit angle is corresponding to the first steering angle interval of the steering angle. The second phase-shift unit angle interval of the phase-shift unit angle is corresponding to the second steering angle interval of the steering angle. According to the conception of the present disclosure, when the aforementioned phase-shift unit angle between the RF signals is in the first phase-shift unit angle interval, since the beam of array antenna 2 is steered at a small steering angle in the first steering angle interval, the grating lobe gain doesn't have influence on the main beam gain. Consequently, the compensation angle is adjusted to a first compensation angle for example substantially zero degree. That is, there is no need to adjust the phase leading or lagging of a specific RF signal, or the first compensation angle is adjusted to be between −3 degrees and +3 degrees. Consequently, the error is corrected. In addition, when the aforementioned phase-shift unit angle between the RF signals is in the second phase-shift unit angle interval, since the beam of array antenna 2 is steered at a large steering angle in the second steering angle interval, the grating lobe gain has influence on the main beam gain. Therefore, the compensation angle is adjusted to the second compensation, which has a specific angle range exclusive zero degree. That is, it is needed to adjust the phase leading or lagging of the specific RF signal. By using the antenna array structure and phase-shift control method of the phase-control array antenna module 1 of the present disclosure, the grating lobe gain of the array antenna 2 is suppressed or reduced when the beam steers at a large steering angle, and the maximum angle range of the beam steering can be expended as well as the dynamic range at large steering angles.

In some embodiments, the first steering angle interval includes a steering angle of substantially 0°. The second steering angle interval does not include a steering angle of 0° and the absolute value of the second steering angle interval is greater than the absolute value of the first steering angle interval. The absolute value of the second phase-shift unit angle interval is greater than the absolute value of the first phase-shift unit angle interval. In some embodiments, the second compensation angle is in the range between 85° and 95°, or in the range between −85° and −95°. In some other embodiments, the second compensation angle is ±90°. In some other embodiments, the first phase-shift unit angle interval is in the range between −95° and +95°, or in the range between −90° and +90°. The second phase-shift unit angle interval is in the range between −180° and +180° but excluding the interval between −95° and +95°, or in the range between −180° and +180° but excluding the interval between −90° and +90°.

Please refer to FIGS. 4, 5A, 5B and 6 again. In this embodiment, the phase-control array antenna module 1 of the present disclosure mainly uses the concept of mutual cancellation of peaks and troughs in near-field standing waves within an extremely short distance. The array antenna 2 is designed to have the positional arrangement difference between two adjacent sub-antenna rows (columns) (based on the application needs for Az (θ-y, θ−Az), or EL (θ-x, θ-EL)) to be one-quarter wavelength of air, which is the phase difference of 90° (w). In the array antenna 2, the odd-numbered sub-antenna rows (columns) maintain the original arrangements thereof, but the even-numbered sub-antenna rows (columns) are retracted (inwardly retracted) by one quarter wavelength of air. Consequently, the constructive interference grating lobes caused by the fixed phase difference) (ψ) (180° between the adjacent antenna units of the array antenna 2 are destroyed. Theoretically, it is to change the mathematical model of the grating lobes. In addition, odd-numbered sub-antenna rows (columns) and even-numbered sub-antenna rows (columns) include a plurality of identical sub-antennas 21 arranged in the row (column) direction, wherein each sub-antenna 21 includes at least one antenna unit 22, and the aforementioned spacing D2 is formed between any two adjacent antenna units 22.

Please refer to FIG. 3 again. The beam steering unit 3 of the phase-control array antenna module 1 of the present disclosure includes a phase and power controller 31, a phase shifter 32, a power attenuator 33, and a switch assembly 34. The phase and power controller 31 is served as a software and firmware control center and includes a phase controller 35 and a power controller 36. The phase controller 35 is configured to control the phase of the RF signal, thereby adjusting the beam direction of the RF signal. By changing the phase of the RF signal transmitted by the antenna unit 22 of each sub-antenna 21 of the array antenna 2, the RF signal can be enhanced in a specific direction, thereby forming a beam pointing toward a specific direction. The power controller 36 is configured to control the power output of the antenna unit 22 of each sub-antenna 21 of the array antenna 2, thereby controlling the shape and strength of the beam of the output RF signal and suppressing side lobes as required. The phase shifter 32 is configured to adjust the phase shift of the output RF signal under the control of the phase controller 35, thereby achieving more precise beam pointing control and grating lobe gain suppression. The power attenuator 33 is configured to adjust the power output of the antenna unit 22 of each sub-antenna 21 of the array antenna 2 under the control of the power controller 35, thereby suppressing side lobes or reducing interference. The switch assembly 34 is connected between the corresponding sub-antenna 21 of the array antenna 2 and the power attenuator 33, thereby switching the transmission direction of the RF signal. In an embodiment, the switch assembly 34 includes two switches. In some embodiments, the beam steering unit 3 further includes a power amplifier PA and a low-noise amplifier (LNA). The power amplifier PA is connected between the two switches of the switch assembly 34 and is configured to amplify the high-frequency RF signal transmitted by the corresponding antenna unit of the sub-antenna. The low-noise amplifier is connected between the two switches of the switch assembly 34 and is configured to amplify the high-frequency RF signal transmitted by the corresponding antenna unit of the sub-antenna. By using the aforementioned beam steering unit 3, the RF signal output by the antenna unit 22 of each sub-antenna 21 of the array antenna 2 is controlled to steer toward a desired angle, and the amplitude (power) and phase of the RF signal are adjusted to control the direction and shape of the main beam, thereby achieving beamforming and beam steering. In one embodiment, preferably but not exclusively, the carrier frequencies of the plurality of RF signals RF1−1, RF1−2, RF1−3, RF1-4 are in the range between 27 GHz and 30 GHz.

In an embodiment, taking the 8×8 array antenna 2 as an example, when the phase-shift unit angle (i.e., linear phase-shift unit (ψ)) between RF signals is within ±90° (for example, the phase-shift unit angle is within the first phase-shift unit angle interval), the corresponding steering angle (or pointing angle) of the beam of the array antenna 2 is within ±30° (i.e., inner boundary scanning angle) (i.e., the steering angle is a small steering angle (θ) within the first steering angle interval), resulting in neither excessive grating lobes nor effects of the dynamic range. For example, when the phase difference or the phase-shift unit angle (ψ-y) of the RF signal from the two adjacent sub-antennas 21 in the Y-axis (azimuth angle (AZ) (θ-y, θ-Az)) direction increases, the steering angle of the beam of the array antenna 2 in the Y-axis direction will increase accordingly. For example, when the phase difference or the phase-shift unit angle (ψ-y) of the RF signal from the two adjacent sub-antennas 21 in the X-axis (elevation angle (EL) (θ-x, θ-EL)) direction increases, the steering angle of the beam of the array antenna 2 in the X-axis direction will increase accordingly.

However, when the phase-shift unit angle (ψ) between RF signals is greater than ±90° (for example, the phase-shift unit angle is within the second phase-shift unit angle interval), the corresponding steering angle (or pointing angle (θ)) of the beam of the array antenna 2 is greater than ±30° (i.e., the steering angle is a large steering angle (θ) within the second steering angle interval), the grating lobe gain increases gradually. Especially, when the phase-shift unit angle (ψ) is greater than ±120° or ±150° (i.e., the boundary phase angle), the corresponding steering angle (or pointing angle (θ)) of the beam of the array antenna 2 is greater than ±45° (i.e., the steering angle is a large steering angle (θ) within the second steering angle interval) and the difference between increased grating lobe gain and main beam gain is less than 10 dB. The grating lobes can be suppressed or eliminated by the following two methods. The first method is to add (or subtract) the second compensation angle of 90° to the linear phase-shift value set Θe for each sub-antenna of the even-numbered sub-antenna rows (columns) of the array antenna, but the linear phase-shift value set Θe for each sub-antenna of the odd-numbered sub-antenna rows (columns) are maintained with the original values or added (or subtracted) with the first compensation angle of 0° ˜3°. The second method is to maintain the linear phase-shift value set Θₑ with the original values or add (or subtract) the first compensation angle of 0° ˜3° to the linear phase-shift value set Θₑ for each sub-antenna of the even-numbered sub-antenna rows (columns) of the array antenna 2, but the linear phase-shift value set Θₑ for each sub-antenna of the odd-numbered sub-antenna rows (columns) are added (or subtracted) with the second compensation angle of 90°. These two aforementioned methods are defined as “irregular phase-shift” methods respectively. According to the conception of the present disclosure, the structure design of the array antenna 2 is mainly to physically arrange the position of the two adjacent sub-antenna rows (columns) with a phase difference of 90° (w), then use the pre-design beam steering control table and add (or subtract) the second compensation angle of 90° to the linear phase-shift value set Θₑ for each sub-antenna unit of the even-numbered sub-antenna rows (columns). It demonstrates that the constructive interference caused by the fixed phase difference) (180°) between any two adjacent sub-antenna rows (columns) is destroyed. The mathematical equation of the grating lobes is changed (as described in the theoretical basis below), so that the grating lobes at large steering angles (θ) or large phase-shift angles (θ) can be suppressed or eliminated.

According to the concept of the present disclosure, the theoretical basis of the structure and the control method of the phase-control array antenna module 1 of the present disclosure is briefly described as follows. Any array factor (AF) of the array antenna can be defined as the inner product of the steering vector and the array manifold vector, and the array factor of the array antenna represents the power distribution of the array antenna receiving and transmitting beams in different directions. The steering vector represents the steering direction of the beam of the array antenna, and the array manifold vector represents the phase and amplitude corresponding to each antenna unit in the array antenna. The array manifold vector is

$$\vec{v} ( ψ ) = {e}^{j ( n \frac{N - 1}{2} ) ψ} ,$$

wherein
ψ is the phase difference of the plane wave coming from any direction to the two adjacent sub-antenna rows (columns), n is the nth array element, N is the number of elements in the entire array, and (N−1)/2 is the center position of the reference actual array antenna. From a simple geometric, ψ can be expressed by the following formula (1):

$$ψ = \frac{2 π}{λ} d \times sin θ , \qquad ( 1 )$$

wherein d is the spacing interval between two adjacent antenna units, A is the wavelength, and (θ) is the incidence angle (i.e., beam pointing angle) of the plane wave. When θ=90°, the plane wave is incident orthogonally to the array antenna (from optical axis calibration boresight). For the uniformly weighted (un-tapered) uniform linear array antenna, its steering vector is served as the array manifold vector and is “steering” towards the target phase ψ_{T}, which is different from the actual phase y of the incident signal. The obtained normalized array factor AF is a function of the phase difference, ψΔ=ψ−ψ_{T}, as the following equation (2),

$$AF = \frac{1}{N} {\vec{v}}^{H} ( {ψ}_{T} ) \vec{v} ( ψ ) = {\sum }_{n - 0}^{N - 1} {e}^{- j ( n \frac{N - 1}{2} ) {ψ}_{T}} {e}^{j ( n \frac{N - 1}{2} ) ψ} = \frac{1}{N} {e}^{- j \frac{N - 1}{2} {ψ}_{Δ}} {\sum }_{n - 0}^{N - 1} {e}^{jn {ψ}_{Δ}} = \frac{sin ( N \frac{{ψ}_{Δ}}{2} )}{N sin \frac{{ψ}_{Δ}}{2}} , - ∞ < {ψ}_{Δ} < ∞ . \qquad ( 2 )$$

The above array factor AF is periodic. According to L′Hôpital's law, when the numerator and denominator of the array factor AF (i.e., the equation (2)) series are both equal to 0, the value of array factor AF series will be maximized. Therefore, when ψ_{Δ}=2nπ, the overall vector of array factor AF will be maximized for all integers n. Back to the definition of incident angle θ, it is expected that no grating lobe is generated during the process of electronically steering the array antenna in the entire visible region (extending from θ=−90° to θ=+90°.

From the aforementioned requirements, it is noted that the interval between the grating lobes is at least 180°. According to the definition of ψ, the maximum value of the grating lobes will be generated according to the following equation (3):

$$2 π n = \frac{2 π}{λ} d \times ( sin θ - sin {θ}_{T} ) , \qquad ( 3 )$$

The first grating lobe occurs at the position of |n|=1. When the beam is steered at the position of θ=90°, the grating lobe can't approach to θ=−90°. Thus, d=2πλ/(2π(1+1))=λ/2. Actually, if the n value is not large, the grating lobe will occur within less than half wavelength of air. That is, d<λ/2 means that the grating lobes appear within the visible range of ±90°. When the value of n is smaller, the angle of the grating lobe occurred is less.

In light of this, in the phase-control array antenna module 1 of the present disclosure, two adjacent sub-antenna rows (columns) are stagged with each other by leading or lagging λ/4 (i.e., 90°), which is used to change the equivalent d value of the AF formula ψ_{Δ}=ψ−ψ_{T}=(2π/λ) d×sinθ−ψ for the entire array antenna from λ/2 originally to λ/4. When ψ_{Δ}=2nπ, the situation of the maximum value in the overall AF vector obtained for all integers n has changed. The maximum grating lobe gain originally at λ/2 has been changed and eliminated. The following briefly describes the structure and the phase-shift control method of the phase-control array antenna module 1 of the present disclosure.

If the beam of the array antenna 2 is steered at a large steering angle (θ) in the positive direction (e.g., the linear phase-shift unit (ψ) is within the large steering angle (θ) interval greater than) 90°, the aforementioned irregular phase-shift method is performed to compensate the distance phase whose original d value is less than λ/2. Therefore, the linear phase-shift value y of the lagging sub-antenna row (column) of the two adjacent sub-antenna rows (columns) is subtracted by 90° (i.e., phase leading λ/4), or the linear phase-shift value y of the leading sub-antenna row (column) of the two adjacent sub-antenna rows (columns) is added by 90° (i.e., phase lagging λ/4). Thus, at large steering angle, the grating lobes in the negative angle direction are suppressed or eliminated.

If the beam of the array antenna is steered at a large steering angle (θ) in the negative direction (e.g., the linear phase-shift unit (ψ) is within the large steering angle (θ) interval less than)−90°, the aforementioned irregular phase-shift method is performed to compensate the distance phase whose original d value is less than λ/2. Therefore, the linear phase-shift value y of the lagging sub-antenna row (column) of the two adjacent sub-antenna rows (columns) is added by 90° (i.e., phase lagging λ/4), or the linear phase-shift value y of the leading sub-antenna row (column) of the two adjacent sub-antenna rows (columns) is subtracted by 90° (i.e., phase leading λ/4). Thus, at large steering angle, the grating lobes in the positive angle direction are suppressed or eliminated.

If the beam of the array antenna is steered at a small steering angle (θ), since the small steering angle (θ) belongs to small steering angle (θ) interval of the inner boundary scanning angle (e.g., the linear phase-shift unit (ψ) is within the small steering angle interval within)±90°, the grating lobe gain is very low. Under this circumstance, the compensation for the distance phase of the original d value less than λ/2 is not needed, so that the boresight angle deviation caused by compensating the distance phase λ/2 is avoided.

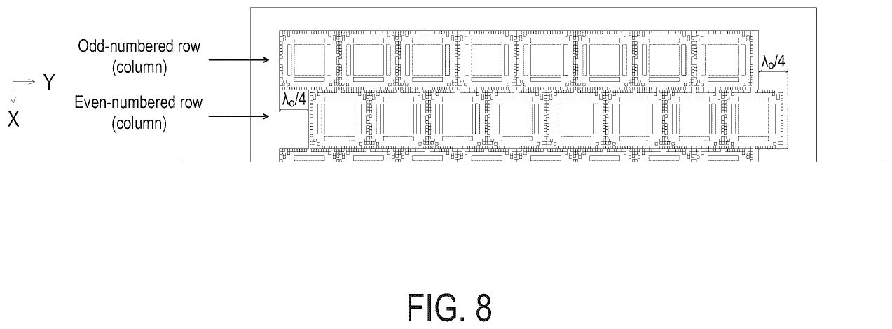

For example, as shown in FIG. 8, one of the sub-antenna rows (columns) of the array antenna 2 has N sub-antennas, and the array antenna 2 is steered at a large steering angle (θ) to suppress the grating lobe gain and increase its dynamic range. Alternatively, when the array antenna 2 is steered at small steering angle, the linear phase-shift value set Θₒ of the odd-numbered sub-antenna rows (columns) and the linear phase-shift value set Θₒ of the even-numbered sub-antenna rows (columns) of the array antenna 2 are set according to the following method to construct a beam steering control table (hereinafter also referred to as Beam Table).

In the embodiment, if the beam of the array antenna 2 is steered at a large steering angle in the positive direction (e.g., the linear phase-shift unit (ψ) is within the large steering angle (θ) interval greater than) 90°, the irregular phase-shift arrangement and the phase-shift control method are employed and described as follows:
1. The linear phase-shift value (ψ) of the odd-numbered (i.e., the leading) sub-antenna rows (columns) maintains unchanged, and the linear phase-shift value (ψ) of the even-numbered (i.e., the lagging) sub-antenna rows (columns) is added by 90° (i.e., the second compensation angle).
(1). The linear phase-shift value set Θₒ of the odd-numbered sub-antenna rows (columns) is as follows:
Θₒ=[0°, Δψ, 2Δψ, 3Δψ, . . . , (N−1) Δψ], wherein N is an integer, and Δψ is the linear phase-shift unit.
(2). The linear phase-shift value set Θₒ of the even-numbered sub-antenna rows (columns) is as follows:

$$Θ e = [ + 90 ° , Δψ + 90 ° , 2 Δψ + 90 ° , … , ( N - 1 ) Δψ + 90 ° ] .$$

2. The linear phase-shift value (ψ) of the odd-numbered (i.e., the leading) sub-antenna rows (columns) is subtracted by 90° (i.e., the second compensation angle), and the linear phase-shift value (ψ) of the even-numbered (i.e., the lagging) sub-antenna rows (columns) maintains unchanged.
(1). The linear phase-shift value set Oo of the odd-numbered sub-antenna rows (columns) is as follows:
Θₒ=[−90°, Δψ−90°, 2Δψ−90°, . . . , (N−1) Δψ−90°], wherein N is an integer, and Δψ is the linear phase-shift unit.
(2). The linear phase-shift value set Θₒ of the even-numbered sub-antenna rows (columns) is as follows:

$$Θ e = [ 0 ° , Δψ , 2 Δψ , 3 Δψ , … , ( N - 1 ) Δ ψ ] .$$

In an embodiment, if the beam of the array antenna 2 is steered at a large steering angle in the negative direction, (e.g., the linear phase-shift unit (ψ) is within the large steering angle (θ) interval less than)−90°, the irregular phase-shift arrangement and the phase-shift control method are employed and described as follows:
1. The linear phase-shift value (ψ) of the odd-numbered (i.e., the leading) sub-antenna rows (columns) maintains unchanged, and the linear phase-shift value (ψ) of the even-numbered (i.e., the lagging) sub-antenna rows (columns) is subtracted by 90° (i.e., the second compensation angle).
(1). The linear phase-shift value set Oo of the odd-numbered sub-antenna rows (columns) is as follows:
Θₒ=[0°, Δψ, 2Δψ, 3Δψ, . . . , (N−1) Δψ], wherein N is an integer, and Δψ is the linear phase-shift unit.
(2). The linear phase-shift value set Θₒ of the even-numbered sub-antenna rows (columns) is as follows:

$$Θ e = [ - 90 ° , Δψ - 90 ° , 2 Δψ - 90 ° , … , ( N - 1 ) Δψ - 90 ° ] ∘$$

2. The linear phase-shift value (ψ) of the odd-numbered (i.e., the leading) sub-antenna rows (columns) is added by 90° (i.e., the second compensation angle), and the linear phase-shift value (ψ) of the even-numbered (i.e., the lagging) sub-antenna rows (columns) maintains unchanged.
(1). The linear phase-shift value set Θₒ of the odd-numbered sub-antenna rows (columns) is as follows:
Θₒ=[+90°, Δψ+90°, 2Δψ+90°, . . . , (N−1) Δψ+90°], wherein N is an integer, and Δψ is the linear phase-shift unit.
(2). The linear phase-shift value set Θₒ of the even-numbered sub-antenna rows (columns) is as follows:

$$Θ e = [ 0 ° , Δψ , 2 Δψ , 3 Δψ , … , ( N - 1 ) Δ ψ ] ∘$$

In an embodiment, if the beam of the array antenna performs a small angle steering at the inner boundary scanning angle, (i.e., the linear phase-shift unit (ψ) is at the small steering angle (θ) interval) within ±90°, the phase-shift arrangement and the phase-shift control method are employed and described as follows:
1. The linear phase-shift value set Θₒ of the odd-numbered sub-antenna rows (columns) is as follows:
   Θo=[0°, Δψ, 2Δψ, 3Δψ, . . . , (N−1)Δψ], wherein N is an integer, and Δψ is the linear phase-shift unit.
2. The linear phase-shift value set Oo of the even-numbered sub-antenna rows (columns) is as follows: Θe=[0°, Δψ, 2Δψ, 3Δψ, . . . , (N−1)Δψ+].

Please refer to FIG. 4 again. In an embodiment, taking an 8×8 array antenna 2 as an example, when the main beam synthesized from the multiple microwave radiation field patterns generated by the multiple sub-antennas 21 in the array antenna 2 is required to be pointed to the positive 60° direction (θ) and the grating lobes at the negative angle are needed to be suppressed and eliminated, the design method of the linear phase-shift value of the beam table is as follows. The beam steering formula of the array antenna is shown in the following equation (4). Based on the aforementioned equation (4), the linear phase-shift unit Δψ=φ is calculated when the array antenna 2 points to +60°.

$$\text{?} \qquad ( 4 )$$

$$\text{?} \text{indicates text missing or illegible when filed}$$

The second term is used to find the linear phase-shift unit ¢12 when the array antenna 2 points to 60° as shown below:

$${ϕ}_{12} = 2 π \frac{{d}_{λ2}}{λ} , sin θ = 2 π \frac{\frac{λ}{2}}{λ} sin 60 ° = 2 π \frac{1}{2} \times \frac{\sqrt{3}}{2} = 0.886 π ( Rad ) ⇒ {ϕ}_{12} = 155.88 \approx 150 ° ( Deg ) .$$

Accordingly, the linear phase-shift unit Δψ=φ₁₂ can be obtained. The phase shift layout and the phase-shift control method of the beam table are shown in Table 1 and briefly described below:
1. In two adjacent sub-antenna rows (columns), the linear phase-shift value (ψ) of the odd-numbered (i.e., the leading) sub-antenna rows (columns) maintains unchanged, and the linear phase-shift value (ψ) of the even-numbered (i.e., the lagging) sub-antenna rows (columns) is added by 90° (i.e., the second compensation angle).
(1). The linear phase-shift value set Θₒ of the odd-numbered sub-antenna rows (columns) is as follows:

$$Θ 0 = [ 0 ° , 150 ° , 300 ° , 450 ° , … , 7 \times 150 ° ] , wherein N = 8 , and Δψ = 150 .$$

(2). The linear phase-shift value set Oo of the even-numbered sub-antenna rows (columns) is as follows:

$$Θ e = [ + 90 ° , 240 ° , 390 ° , 540 ° , … , 7 \times 150 ° + 90 ° ] .$$

2. In two adjacent sub-antenna rows (columns), the linear phase-shift value (ψ) of the odd-numbered (i.e., the leading) sub-antenna rows (columns) is subtracted by 90° (i.e., the second compensation angle), and the linear phase-shift value (ψ) of the even-numbered (i.e., the lagging) sub-antenna rows (columns) maintains unchanged.
(1). The linear phase-shift value set Θₒ of the odd-numbered antenna rows (columns) is as follows:

$$Θ 0 = [ - 90 ° , 60 ° , 210 ° , 360 ° , … , 7 \times 150 ° - 90 ° ] , wherein N = 8 , and Δψ = 150 .$$

(2). The linear phase-shift value set Θₒ of the even-numbered antenna rows (columns) is as follows:

$$Θ e = [ 0 ° , 150 ° , 300 ° , 450 ° , … , 7 \times 150 ° ] .$$

TABLE 1
Beam Table (relative to the position of the sub-antenna)

| 0° | Δψ | 2Δψ | 3Δψ | 4Δψ | 5Δψ | 6Δψ | 7Δψ |
|---|---|---|---|---|---|---|---|
| ±90° | Δψ ± 90° | 2Δψ ± 90° | 3Δψ ± 90° | 4Δψ ± 90° | 5Δψ ± 90° | 6Δψ ± 90° | 7Δψ ± 90° |
| 0° | Δψ | 2Δψ | 3Δψ | 4Δψ | 5Δψ | 6Δψ | 7Δψ |
| ±90° | Δψ ± 90° | 2Δψ ± 90° | 3Δψ ± 90° | 4Δψ ± 90° | 5Δψ ± 90° | 6Δψ ± 90° | 7Δψ ± 90° |
| 0° | Δψ | 2Δψ | 3Δψ | 4Δψ | 5Δψ | 6Δψ | 7Δψ |
| ±90° | Δψ ± 90° | 2Δψ ± 90° | 3Δψ ± 90° | 4Δψ ± 90° | 5Δψ ± 90° | 6Δψ ± 90° | 7Δψ ± 90° |
| 0° | Δψ | 2Δψ | 3Δψ | 4Δψ | 5Δψ | 6Δψ | 7Δψ |
| ±90° | Δψ ± 90° | 2Δψ ± 90° | 3Δψ ± 90° | 4Δψ ± 90° | 5Δψ ± 90° | 6Δψ ± 90° | 7Δψ ± 90° |

The structures of the array antenna 2 of the phase-control array antenna module 1 and the phase-shift control method of the present disclosure can be achieved in multiple ways. Different embodiments are described as followings.

Embodiment 1: A phase-control array antenna module 1 includes an array antenna 2 with 8×8 array or greater (inclusive) and performs the irregular phase-shift control at a large steering angle (θ) exceeding ±60° to suppress the grating lobe.

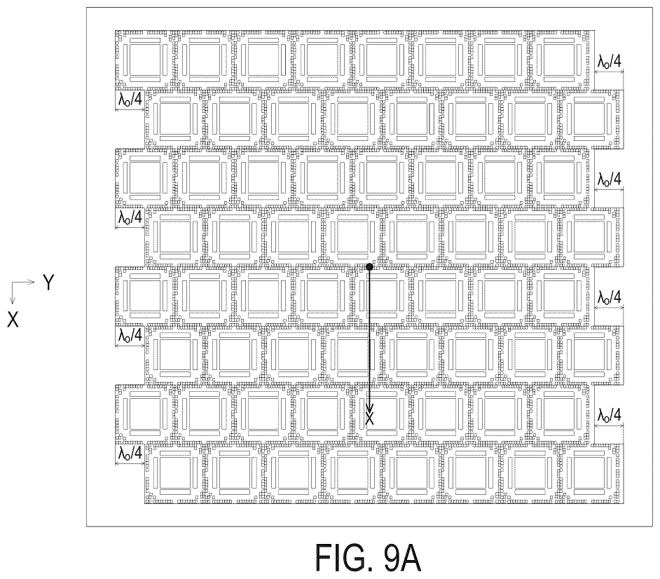

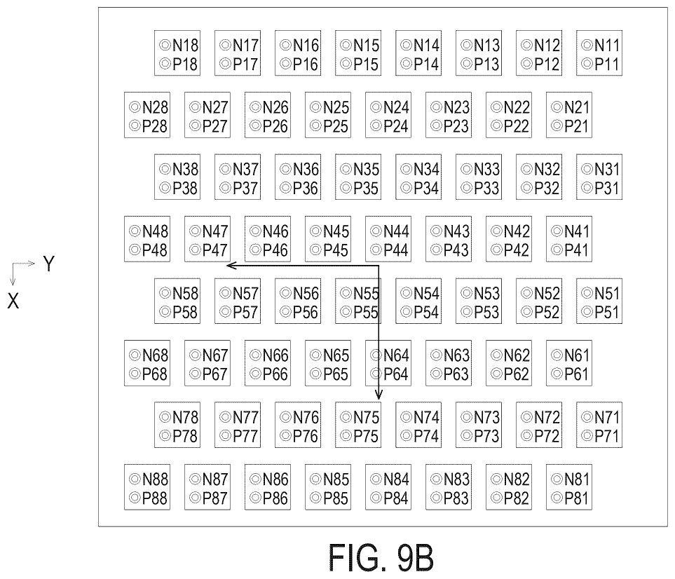

The phase-control array antenna module 1 of this embodiment can expand the beam steering range and dynamic range of the array antenna in azimuth direction or elevation direction. For an 8×8 array antenna, the maximum beam steering range is limited within +60° in general, mainly due to the effect of grating lobe and side lobe leading to the limitation of the dynamic range. That is, the difference between the main beam gain and the grating lobe gain (or the side lobe gain) is less than 10 dB (inclusive), but the side lobe gain can be improved or reduced through weighting (tapering) design. Please refer to FIGS. 9A and 9B, which are front and rear perspective views of the 8×8 array antenna. Each antenna unit of the sub-antenna of the array antenna 2 has a dual-polarization input terminal, wherein the names of the dual-polarization input terminals are defined as N11, N12, . . . , N18, . . . , N81, N82, . . . , N88, and P11, P12, . . . , P18, . . . , P81, P82, . . . , P88, and etc. The aforementioned dual-polarization input terminals are served as codes for the beam steering control table (Beam Table). The linear phase-shift values are substituted into the dual-polarization input terminals with the aforementioned codes to proceed irregular phase-shift control, so that the grating lobe is suppressed and eliminated. In the traditional antenna design, the grating lobes cannot be improved and reduced through weighting design of array antennas. In the embodiment of the present disclosure, the phase-control array antenna module 1 uses the specific array antenna structure, i.e., the positions between two physically adjacent sub-antenna columns or two physically adjacent sub-antenna rows are staggered by a staggered spacing of λ/4. In addition, when the array antenna 2 is steered at large steering angles, the linear phase-shift value of one of the two adjacent sub-antenna rows (columns) is shifted by ±90° (ψ), or the linear phase-shift value of the other of the sub-antenna rows (columns) maintains the original linear phase-shift value (ψ). By using the aforementioned phase-shift control method, the grating lobes in the large-angle directions on both sides of the main beam are suppressed or eliminated when the array antenna is steered at large steering angle (θ).

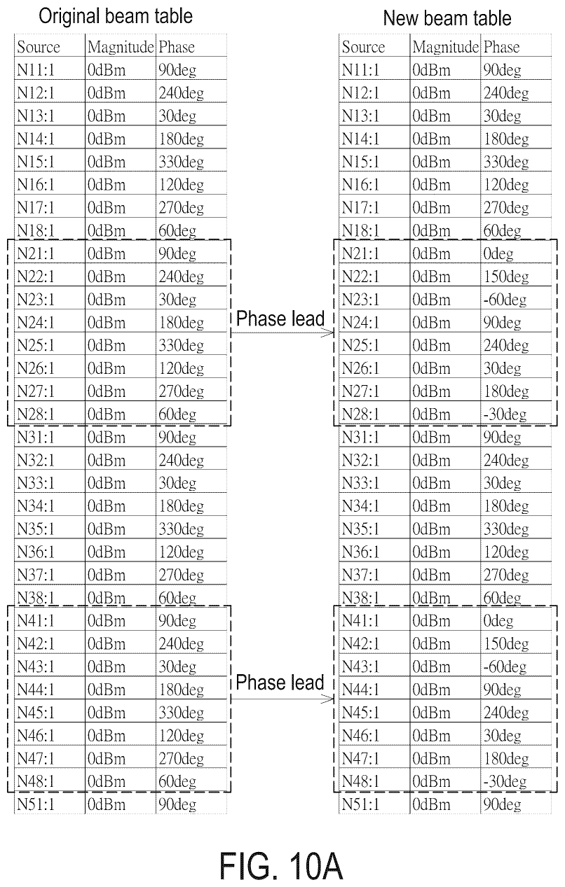

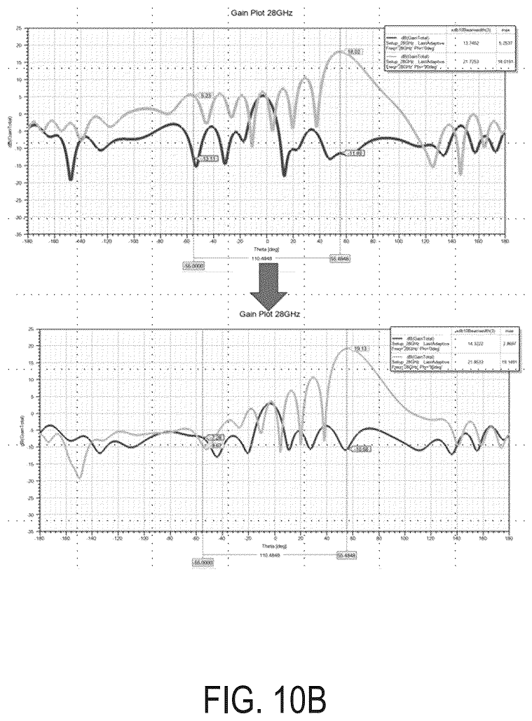

Please refer to FIGS. 10A and 10B. In this embodiment, the array antenna 2 is steered at a large steering angle (θ) (e.g., the linear phase-shift unit is 150°(ψ)). From the beam steering formula of the array antenna, the linear phase-shift unit (ψ) is 155.88° and the array antenna is pointing at 60° in the Az direction (θ-y). In order to simplify the calculation, a linear phase-shift unit of 150° (ψ) is introduced into the simulation analysis. According to the beam table shown in FIG. 10A, the phase-shift value (ψ) of the odd-numbered sub-antenna rows (columns) maintains unchanged and the phase-shift value (ψ) of the even-numbered sub-antenna rows (columns) is subtracted by 90°. As shown in FIG. 10B, the steering of array antenna 2 can only reach 55° in the Az direction (θ-y). The left-side grating lobe is suppressed by more than about 14 dB (=5.23−(−9.67)), while the main beam gain increases 1.11 dB (=19.13−18.02), and the gain difference between the main bean and the grating lobe increases from 12.79 dB (=18.02−5.23) to 28.8 dB (=19.13−(−9.67)).

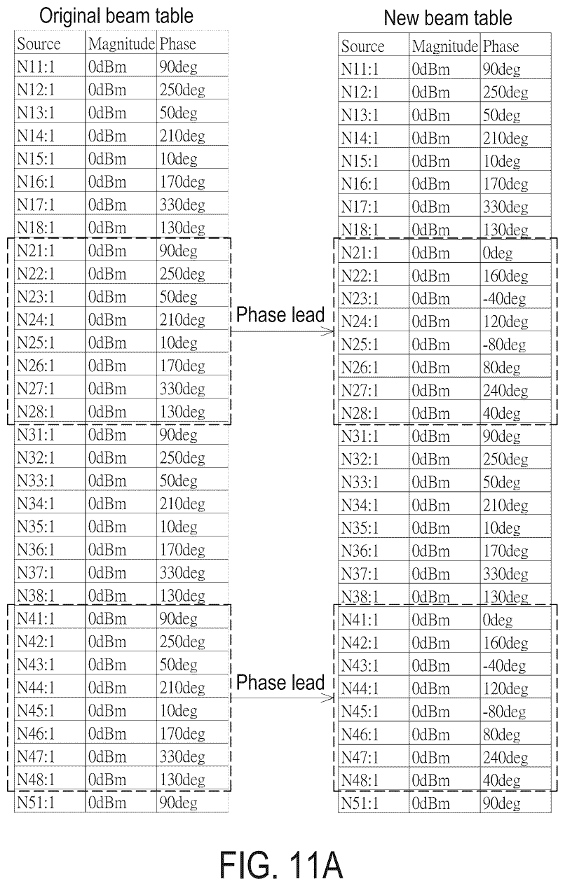

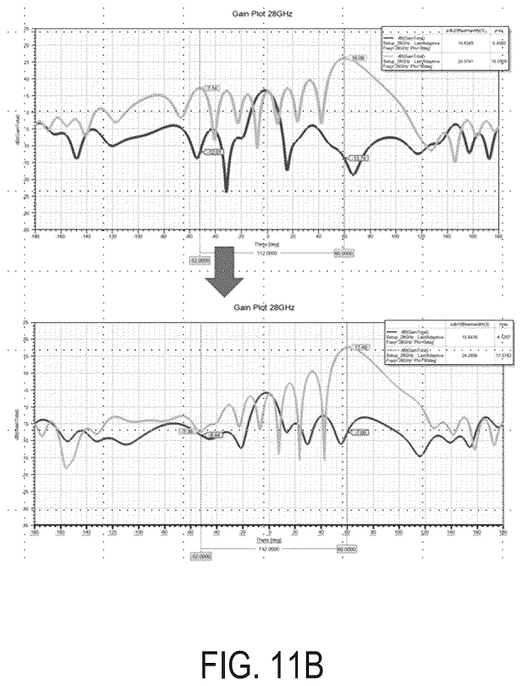

Then, the 8×8 array antenna is steered at a large steering angle (θ), and the phase-shift unit (ψ) of 160° is introduced into the simulation analysis. According to the beam table shown in FIG. 11A, the phase-shift value (ψ) of the odd-numbered sub-antenna columns (rows) maintains unchanged and the phase-shift value (ψ) of the even-numbered sub-antenna rows (columns) is subtracted by 90°. As shown in FIG. 11B, the array antenna 2 is steered at 60° in the Az direction (θ-y), the left-side grating lobe is suppressed by more than 14 dB (=7.14−(−7.36). Meanwhile, the pointing angle reaches 60° (θ-y). Obviously, the gain difference between the main beam and the grating lobe without performing 90° phase compensation is less than 10 dB (=16.09−7.14), while the gain difference between the main beam and the grating lobe with 90° phase compensation is greater than 20 dB (=17.49−(−7.36)). Consequently, the grating lobe gain is suppressed or eliminated effectively by using the phase-control array antenna module 1 of the present disclosure. In some other embodiments, although the side lobe gain is increased slightly, the side lobe gain can be improved and reduced through the weighted design of array antenna.

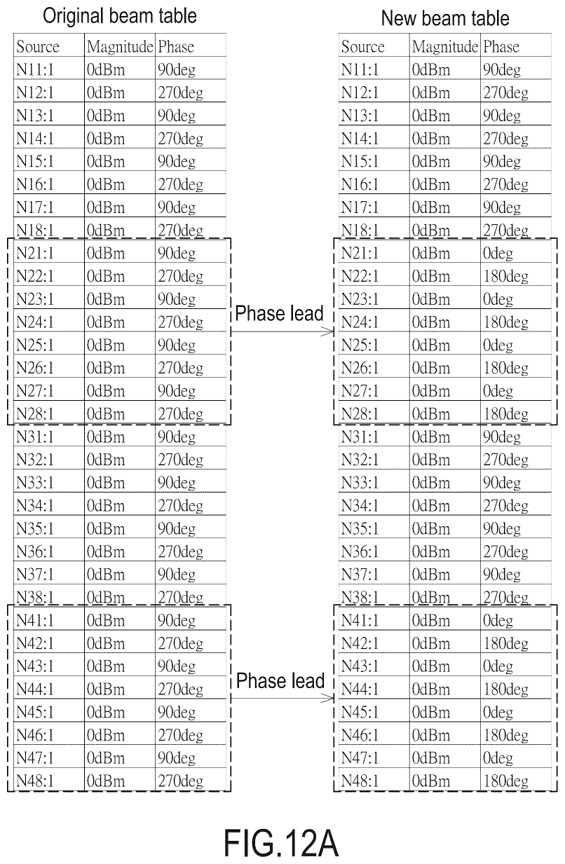

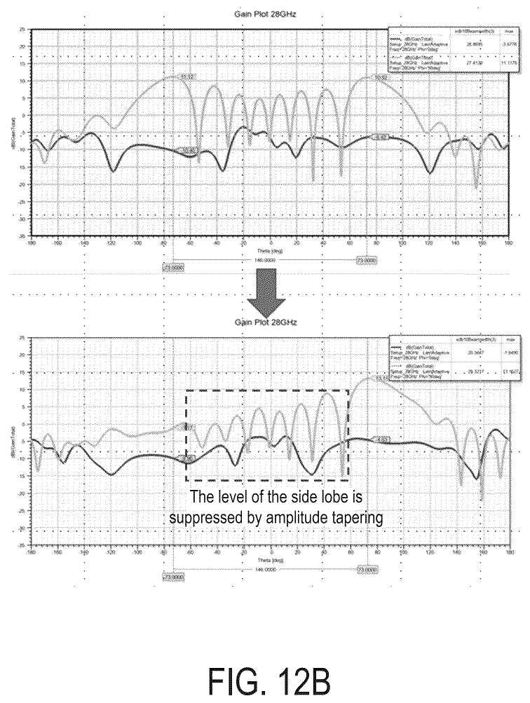

Thereafter, the 8×8 array antenna is steered at a large steering angle (θ) again, and the linear phase-shift unit (ψ) of a maximum value 180° is introduced into the simulation analysis. Please refer to FIGS. 12A and 12B. When the linear phase-shift unit (ψ) is set to be 180° (ψ), the grating lobe gain is substantially equal to the main beam gain, and its maximum angle of steering reaches 73° in the Az (θ-y). In addition, according to the beam steering control table of FIG. 12A, the phase-shift value (ψ) of the odd-numbered sub-antenna rows (columns) maintains unchanged and the phase-shift value (ψ) of the even-numbered sub-antenna rows (columns) is subtracted by 90°. As shown in FIG. 12B, the grating lobe on the left side of the main beam is completely eliminated, and the gain difference between the main beam and the grating lobe is increased from −0.2 dB (=10.92−11.12) to 14.28 dB (=13.11−(−1.17))). Consequently, the grating lobe gain is suppressed or eliminated effectively by using the phase-control antenna module 1 of the present disclosure. In addition, the steering range in the Az direction (θ-y) can be extended from ±60° to ±73°.

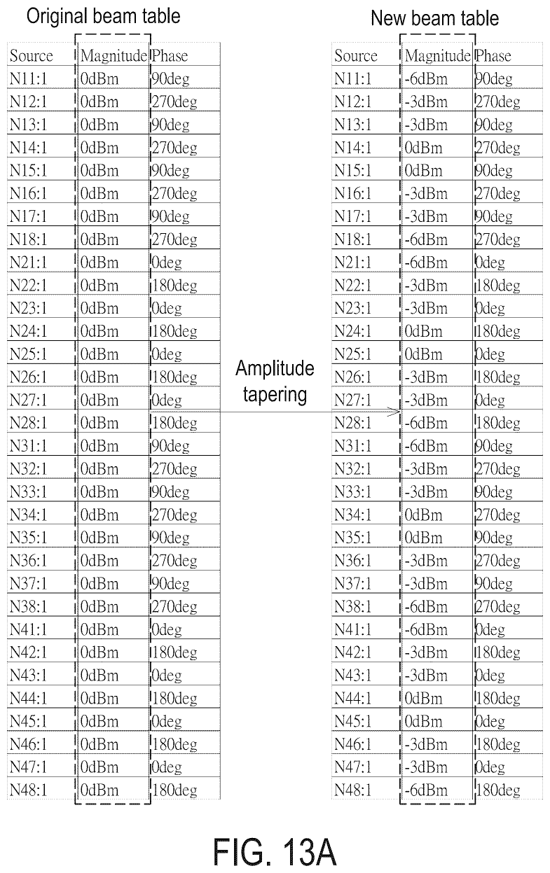

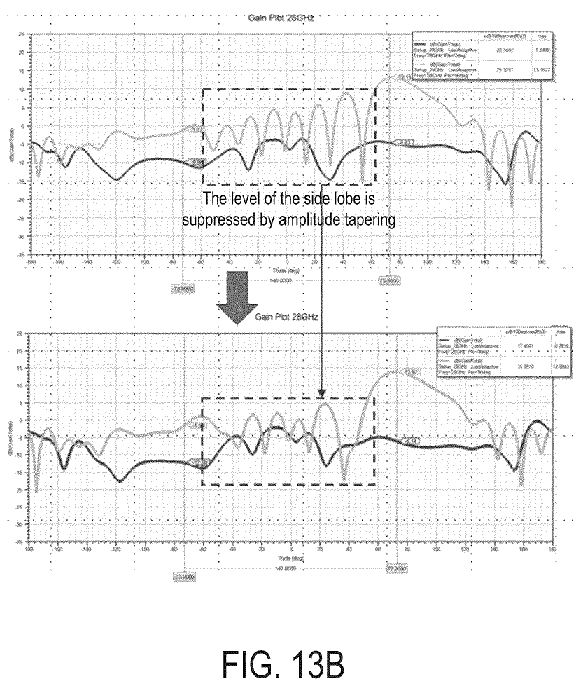

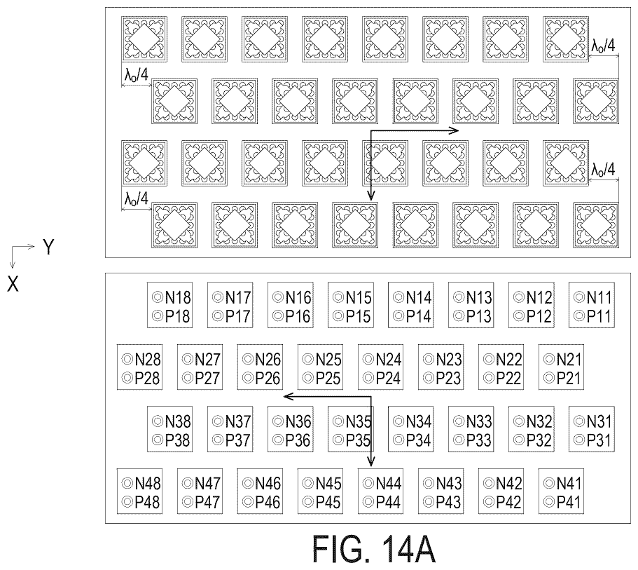

In the aforementioned simulation analysis, although the grating lobe gain is suppressed or eliminated effectively by using the phase-control array antenna module 1 of the present disclosure and the steering range in the Az direction (θ-y) can be extended from ±60° to ±73°, the side lobe gain is still large. In order to solve the aforementioned issue, as shown in FIG. 13A, the phase-control array antenna module 1 can be further optimized by performing amplitude weighting adjustment on the beam steering control table that has been phase compensated. According to the adjusted beam steering control table shown in FIG. 13A, when the array antenna 2 performs beam steering, the side lobe gain is significantly reduced by 4.1 dB (=9.0−4.9). Furthermore, if the side lobe gain needs to be further reduced, the amplitude weighting adjustment can be performed again.

It should be emphasized that the aforementioned simulation analysis is not only applicable to 8×8 array antennas, but also applicable to other array antennas larger than 8×8 array antenna.

Embodiment 2: A phase-control array antenna module 1 includes an array antenna 2 with 4×8 array (or 8×4 array) and performs the irregular phase-shift control at a large steering angle (θ) of ±45° on the short side (on the four rows) thereof.

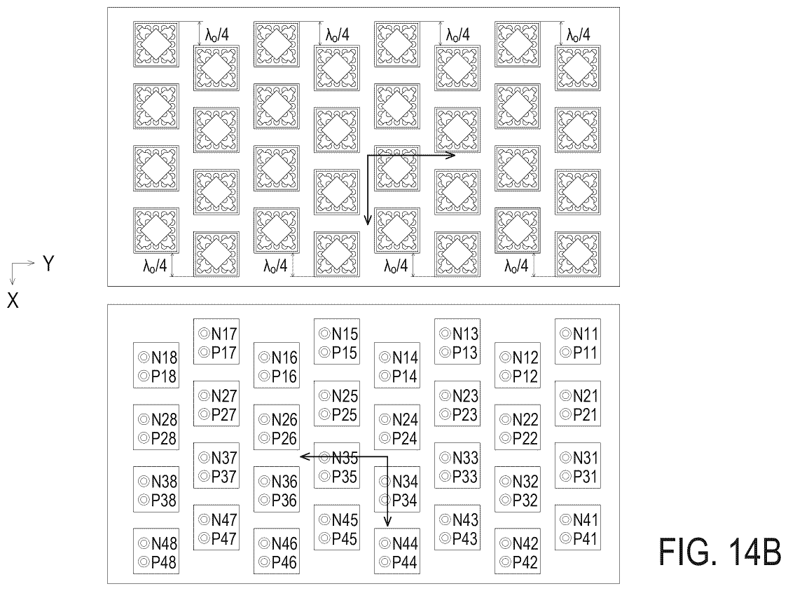

The phase-control array antenna module 1 of this embodiment can expand the beam steering range and dynamic range of the array antenna in azimuth direction or elevation direction. For a 4×8 (or 8×4) array antenna, the maximum beam steering range is limited within ±45° in general, mainly due to the effect of grating lobe and side lobe leading to the limitation of the dynamic range. That is, the gain difference between the main beam and the grating lobe (or side lobe) is less than 10 dB (inclusive), but the side lobe gain can be improved or reduced through weighting (tapering) design. Please refer to FIGS. 14A and 14B, which are front and rear perspective views of the 4×8 array antenna. Each antenna unit of the sub-antenna of array antenna 2 has a dual-polarization input terminal, wherein the names of the dual-polarization input terminals are defined as N11, N12, . . . , N18, . . . , N41, N42, . . . , N48, and P11, P12, . . . , P18, . . . , P41, P42, . . . , P48, and etc. The aforementioned dual-polarization input terminals are served as codes for the beam steering control table (Beam Table). The linear phase-shift values are substituted into the dual-polarization input terminals of the aforementioned codes to proceed irregular phase-shift control, so that the grating lobe is suppressed and eliminated. In the traditional antenna design, the grating lobes cannot be improved and reduced through weighting design of array antennas. In the embodiment of the present disclosure, the phase-control array antenna module 1 uses the specific array antenna structure, i.e., the positions between two physically adjacent sub-antenna columns or two physically adjacent sub-antenna rows are staggered by the staggered spacing of λ/4. In addition, when the array antenna 2 is steered at large steering angles, the linear phase-shift value of one of the two adjacent sub-antenna rows (columns) is shifted by +90° (w), or the linear phase-shift value of the other of the sub-antenna rows (columns) maintains the original linear phase-shift value (ψ). By using the aforementioned phase-shift control method, the grating lobes in the large-angle directions on both sides of the main beam are suppressed or eliminated when the array antenna is steered at large steering angle (?).

In some embodiments, as shown in FIG. 14A, the irregular phase-shift control is performed on the 4×8 (or 8×4) array antenna in the long side direction (Az) (θ-y) to suppress the grating lobe. The structure and method of this embodiment are similar to that of the 8×8 array antenna. The analysis and simulation results have been described above and will not be redundantly described hereinafter. In some other embodiments, as shown in FIG. 14B, the irregular phase-shift control is performed on the 4×8 (or 8×4) array antenna in the short side direction (EL) to suppress the grating lobe, that is the 4×8 (or 8×4) array antenna is steered at a large steering angle of ±45° on the short side of the four sub-antenna rows (columns). Since the array antenna 2 has only four sub-antennas rows (columns), the steering angle is limited to within ±45°. If it can be expanded to ±60°, the application angle range can be expended. In addition to the considerations of the beam width and gain amplitude, the basic functions of the standard 8×8 array antenna can be replaced by the 4×8 (or 8×4) array antenna.

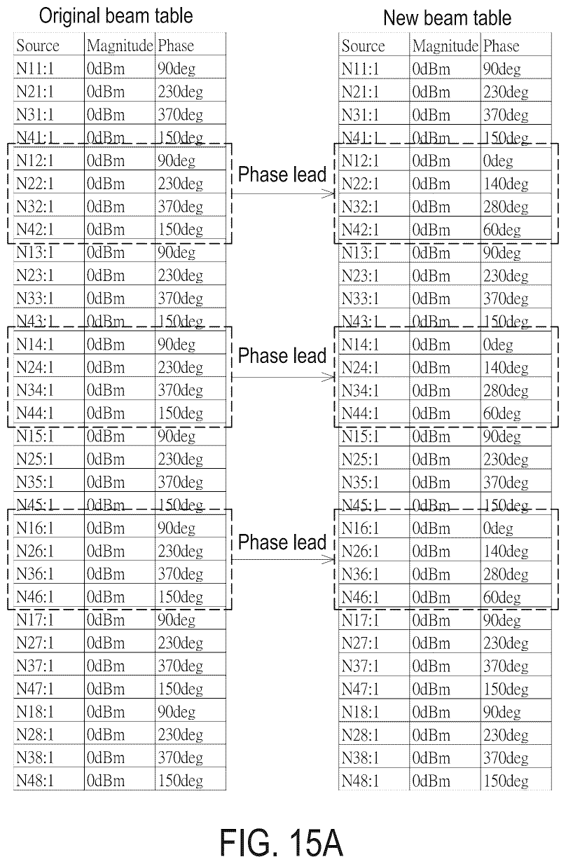

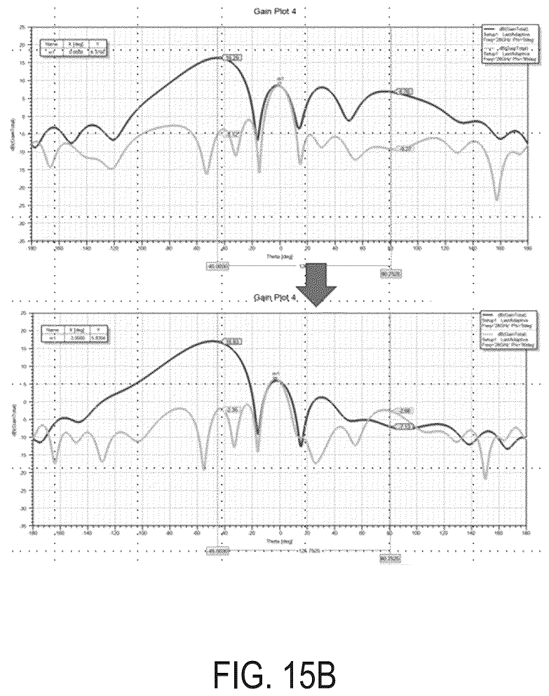

In this embodiment, as shown in FIGS. 14A and 14B, the 4×8 array antenna is steered at a steering angle of −45° in the EV direction (θ-x) (i.e., the linear phase-shift unit (ψ-x) is) 140° and uses the beam steering formula for calculation. If the 4×8 array antenna is required to point to −45° in the EV direction (θ-x), the linear phase-shift unit should be ±127° (or −127°, depending on the arrangement of the feeding point). In the condition without the phase compensation, the beam steering of the array antenna on the four sub-antenna rows (columns) of the short side is close to the limit already, so that the steering in the EL direction reaches −40° only. Thus, a linear phase-shift unit (ψ-x) of 140° is used for steering to achieve the steering at −45° in the EL direction, as shown in the upper field pattern of FIG. 15B. According to the beam steering control table of FIG. 15A, the phase-shift value (ψ) of the odd-numbered sub-antenna rows (columns) maintains unchanged and the phase-shift value (ψ) of the even-numbered sub-antenna rows (columns) is subtracted by 90°. Accordingly, the lower field pattern of FIG. 15B for the array antenna 2 is obtained. Obviously, the right-side grating lobe is suppressed by approximately 13.89 dB (=6.76−(−7.13)) and the main side lobe gain is reduced from 8.38 dB to 5.83 dB. The gain difference between the main beam and the grating lobe increases from 9.53 dB (=16.29−6.76) to 23.96 dB (=16.83−(−7.13)). Consequently, the grating lobe gain is suppressed or eliminated effectively by using the phase-control antenna module 1 of the present disclosure.

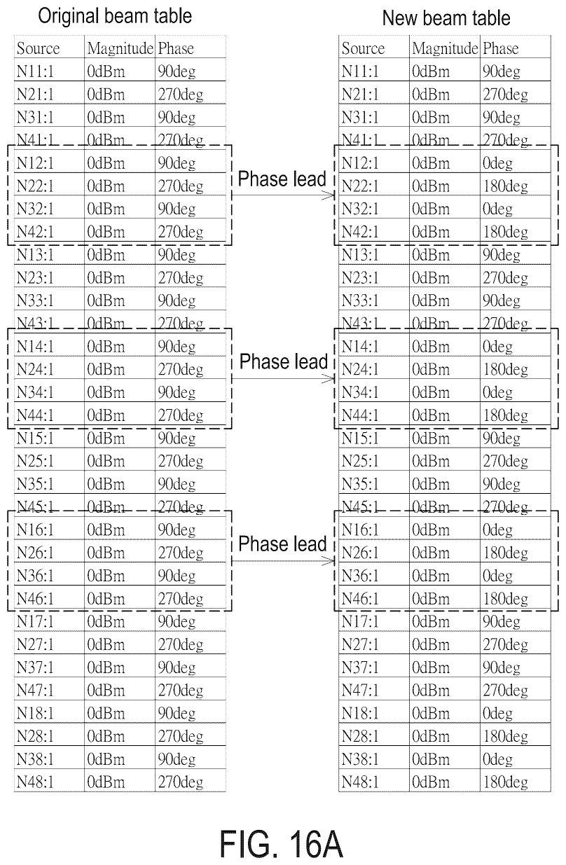

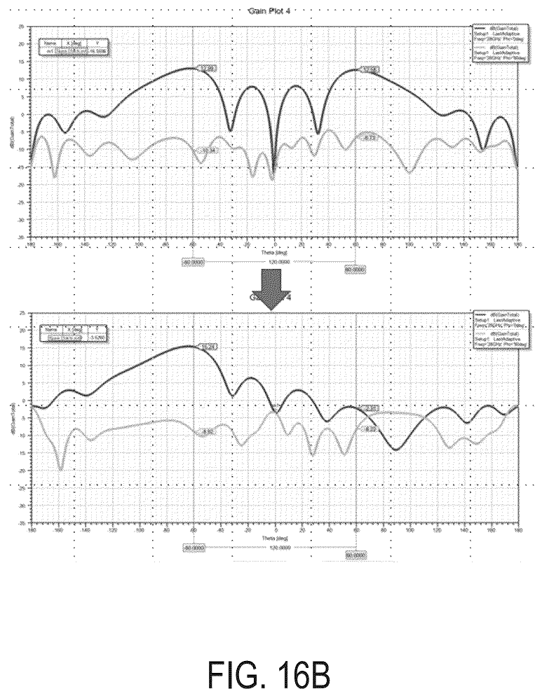

Similar to the Embodiment 1, the 4×8 array antenna is steered at a large steering angle (θ) on the short side thereof in the EL direction, and a linear phase-shift unit of 180° (ψ) is introduced into the 4×8 array antenna as shown in FIG. 14B. At this time, the grating lobe gain is equal to the main beam gain, and this is the maximum steering angle (θ) of the array antenna physically. As shown in the upper field pattern of FIG. 16B, for the array antenna 2, the grating lobe gain in the EL direction is substantially equal to the main beam gain and its maximum steering angle reaches −60° (θ-x). According to the beam steering control table of FIG. 16A, the phase-shift value (ψ) of the odd-numbered sub-antenna rows (columns) maintains unchanged and the phase-shift value (ψ) of the even-numbered sub-antenna rows (columns) is subtracted by 90°. Accordingly, the lower field pattern of FIG. 16B for the array antenna 2 is obtained. The grating lobe on the right side is completely eliminated. Consequently, the steering angle range of the array antenna 2 on the short side in the EL direction can be expanded from +45° to +60°. Meanwhile, the gain difference between the main beam and the grating lobe increases from 0.41 dB (=12.99−12.58) to 17.55 dB (=15.24-(−2.31)). Consequently, the grating lobe gain is suppressed or eliminated effectively by using the phase-control antenna module 1 of the present disclosure. In addition, the steering range in the EL direction (θ-x) can be extended from +45° to +60°.

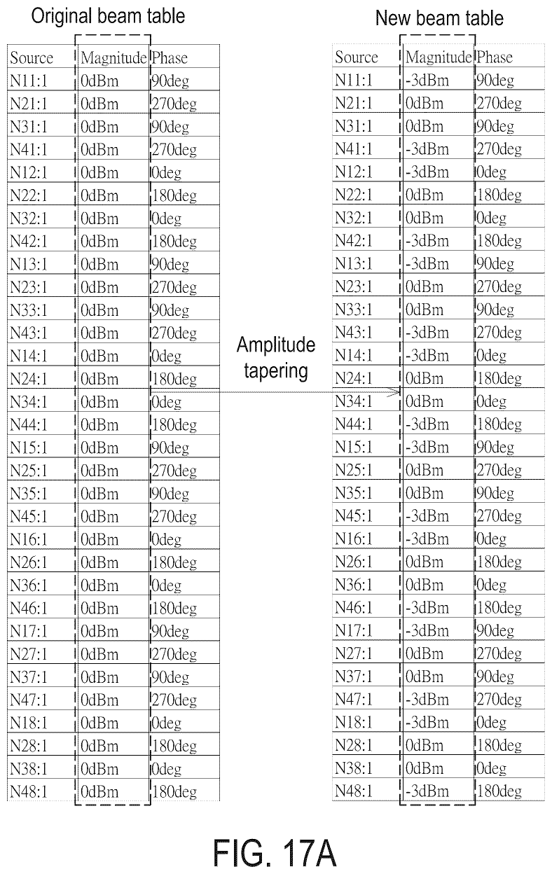

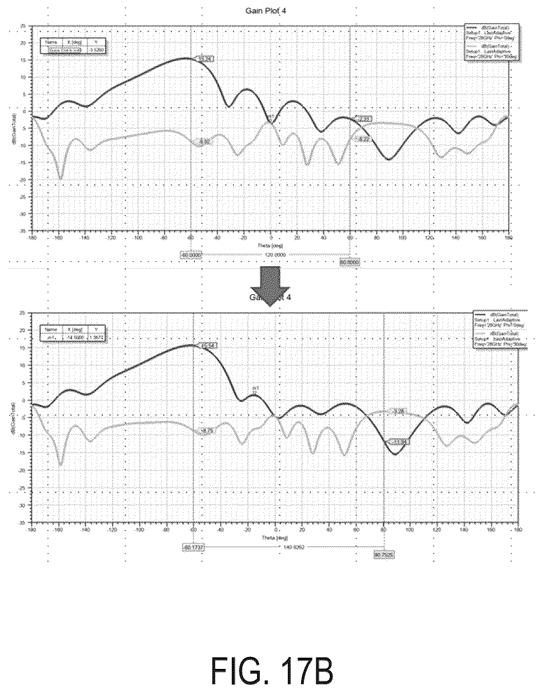

In the aforementioned simulation analysis, although the grating lobe gain is suppressed or eliminated effectively by using the phase-control array antenna module 1 of the present disclosure and the steering range in the EL direction can be extended from ±45° to ±60°, the gain difference between the adjacent main bean and the side lobe is still not reached to 10 db (=15.24−6.5). In order to solve the aforementioned issues, as shown in FIG. 17A, the phase-control array antenna module 1 can be further optimized by performing amplitude weighting adjustment on the beam steering control table that has been phase compensated. According to the adjusted beam steering control table shown in FIG. 17A, when the array antenna 2 performs beam steering, the side lobe gain is reduced so that the gain difference between side lobe and the main beam is equal to or greater than 10 dB (=15.54˜2.4), wherein the gain at 60° is increased by 0.3 dB (=15.54−15.24).

Embodiment 3: The phase-control array antenna module 1 uses an 8×8 (or 4×8) array antenna 2 and the power consumption issue is considered. The two sub-antennas in the azimuth direction are connected to each other and then connected to the beam steering unit. The phase-control array antenna module 1 performs the irregular phase-shift control at the maximum steering angle within ±20° (θ) in azimuth direction to suppress the grating lobe.

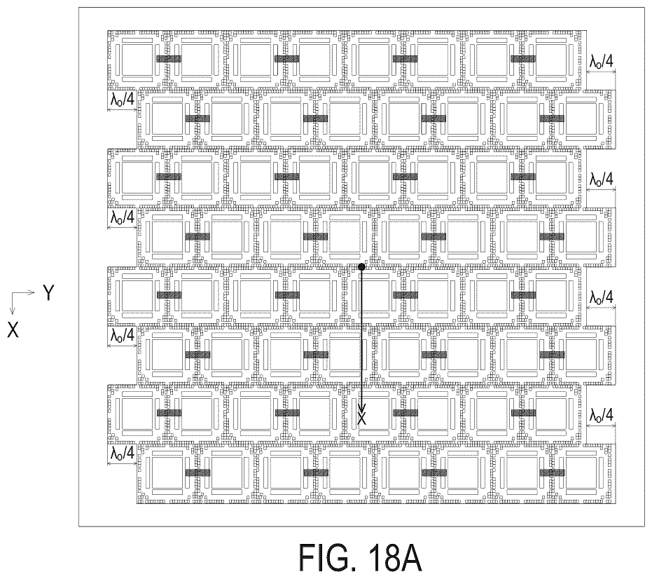

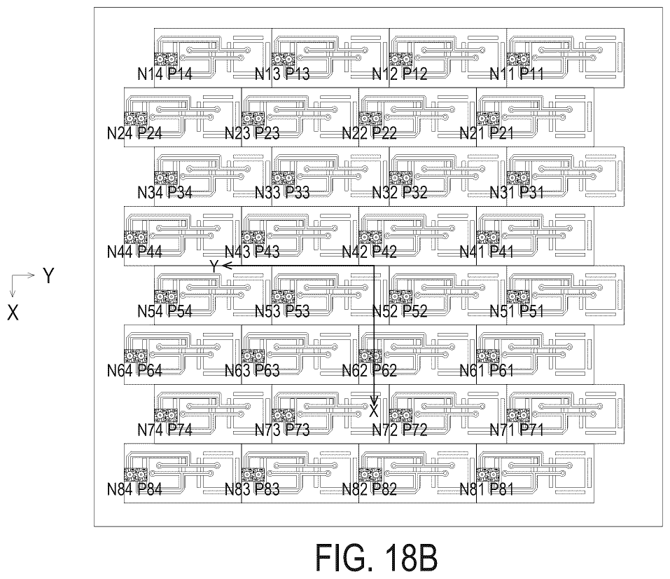

FIGS. 18A and 18B are schematic diagrams illustrating the front and rear circuit configurations of an 8×8 (or 4×8) array antenna with two sub-antennas in the azimuth direction connected to each other. In this embodiment, power consumption issues of the 8×8 or 4×8 array antenna architecture is considered, two sub-antennas of the 8×8 array antenna in the azimuth (Az) direction (y-axis) are connected to each other and then connected to the beam steering units. As shown in FIG. 18A, the sub-antennas of the array antenna 2 in the Azimuth direction are connected in pairs. The thick grayscale lines in FIG. 18A depict the connections between the feeding ends (also referred to as the input terminals) of the two sub-antennas. In actual simulation analysis, the phases of the two connected sub-antennas can be set to the same, or the two connected sub-antennas are directly connected to a power distributor. The simulation analysis is performed with the grating lobe suppression within the maximum steering angle of +20° (θ-y) in the Azimuth direction. As shown in FIG. 18B, each antenna unit of the sub-antenna of the array antenna 2 has a dual-polarization input terminal, wherein the names are defined as N11, N12, . . . , N18, . . . , N41, N42, . . . , N48, and P11, P12, . . . , P18, . . . , P41, P42, . . . , P48 and etc. The aforementioned dual-polarization input terminals are served as codes for the beam steering control table (Beam Table). The linear phase-shift values are substituted into the dual-polarization input terminals with the aforementioned codes to proceed irregular phase-shift control, so that the grating lobe is suppressed and eliminated. In the traditional antenna design, the grating lobes cannot be improved and reduced through weighting design of array antennas. In the embodiment of the present disclosure, the phase-control array antenna module 1 uses the specific array antenna structure, i.e., the positions between two physically adjacent sub-antenna columns or two physically adjacent sub-antenna rows are staggered by the staggered spacing of λ/4. In addition, when the array antenna 2 is steered at large steering angles, the linear phase-shift value of one of the two adjacent sub-antenna rows (columns) is shifted by the second compensation angle of ±90° (v), or the linear phase-shift value of the other of the sub-antenna rows (columns) maintains the original linear phase-shift value (ψ). By using the aforementioned phase-shift control method, the grating lobes in the large-angle directions on both sides of the main beam are suppressed or eliminated when the array antenna is steered at large steering angle (θ).

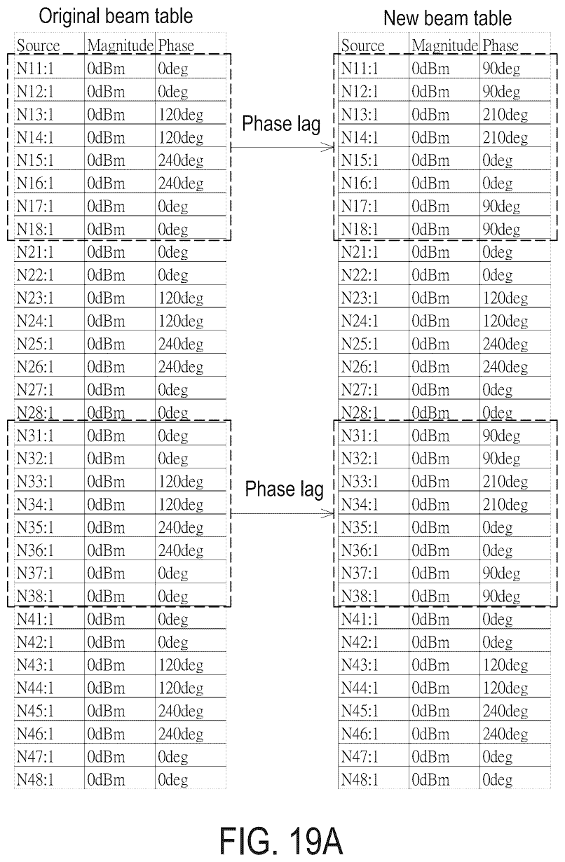

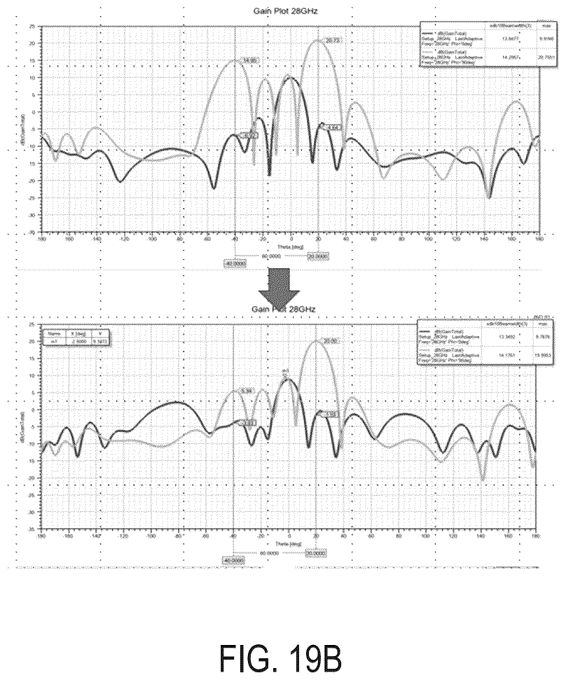

Please refer to FIGS. 19A and 19B. In this embodiment, the array antenna 2 is steered at +20° in the Az direction (θ-y) (i.e., the linear phase-shift unit (ψ) is) 120°. According to the beam steering control table shown in FIG. 19A, the phase-shift value (ψ) of the odd-numbered sub-antenna rows (columns) is added by 90°, and the phase-shift value (ψ) of the even-numbered sub-antenna rows (columns) maintains unchanged. As shown in FIG. 19B, the grating lobe gain on the left side is suppressed effectively by approximately 9.6 dB (=14.95−5.34), and the main beam gain is decreased slightly by 0.7 dB (=20.73−20). The gain difference between the main beam and the grating lobe increases from 5.78 dB (=20.73−14.95) to 14.66 dB (=20−5.34).

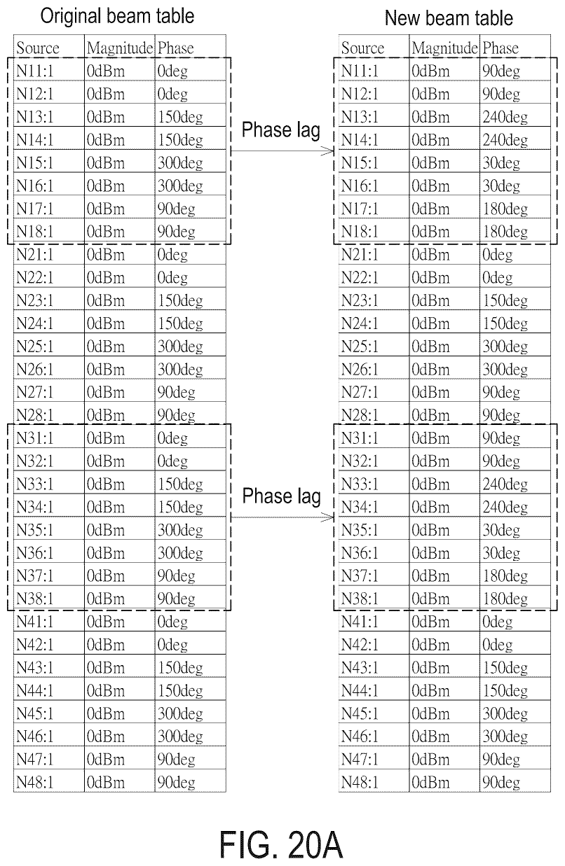

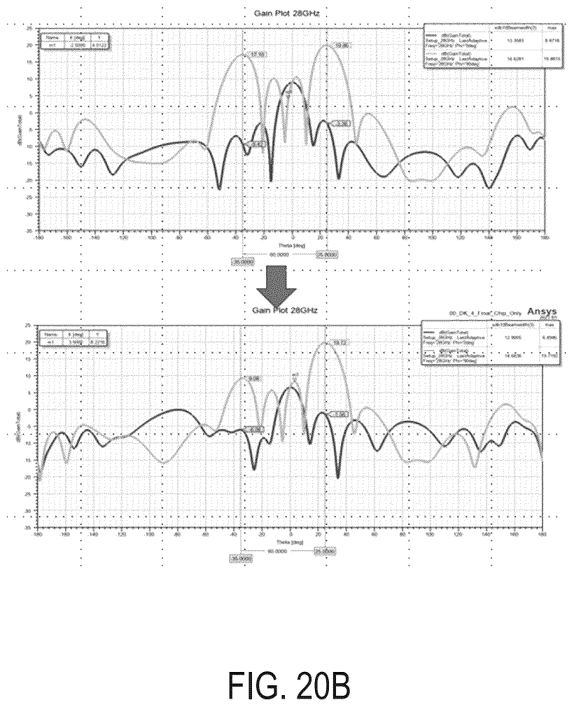

Similarly, the phases of the two sub-antennas connected with each other in the array antenna 2 are set to be the same, and the array antenna 2 is steered a +25° in the Azimuth direction (θ-y) (e.g., the linear phase-shift unit (ψ-y) is) 150°. According to the beam steering control table shown in FIG. 20A, the phase-shift value (ψ-y) of the odd-numbered sub-antenna rows (columns) is added by 90°, and the phase-shift value (ψ) of the odd-numbered sub-antenna rows (columns) maintains unchanged. As shown in FIG. 20B, the grating lobe gain on the left side is suppressed effectively by approximately 8.02 dB (=17.10−9.08), but the main beam gain is decreased slightly by 0.14 dB (=19.86−19.72). By performing the phase compensation method, the maximum steering angle (θ-y) of the antenna array with two sub-antennas connected in pairs in the Azimuth direction increases from +20° to +25°, and the gain difference between the main beam and the grating lobe increases from 2.76 dB (=19.86−17.10) to 10.64 dB (=19.72−9.08)). Furthermore, after performing phase compensation with a linear phase-shift unit greater than 150°, the gain difference between the main beam and the grating lobe is less than 10 dB, and are not redundantly described hereinafter. Consequently, the grating lobe gain is suppressed or eliminated effectively by using the phase-control antenna module 1 of the present disclosure. In addition, the maximum steering range in the Az direction (θ-y) can be extended from +20° to +25°.

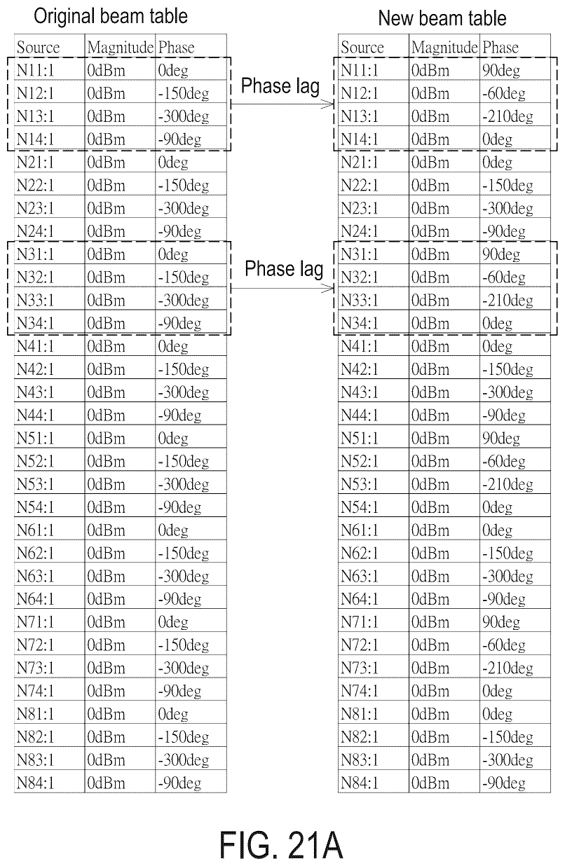

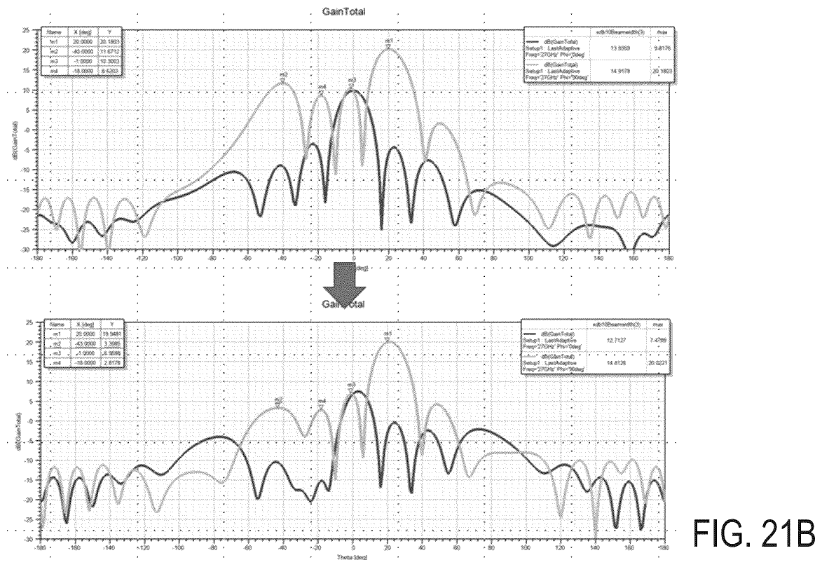

Please refer to FIGS. 18A and 18B. The array antenna uses a power distributor to connect with the two sub-antennas in the Azimuth direction and performs beam steering at +20° in the Azimuth direction (θ-y) (i.e., the linear phase-shift unit (ψ-y) is) 120°. According to the beam steering control table shown in FIG. 21A, the phase-shift value (ψ-y) of the odd-numbered sub-antenna rows (columns) is added by 90°, and the phase-shift value (ψ-y) of the even-numbered sub-antenna rows (columns) maintains unchanged. As shown in FIG. 21B, the grating lobe gain on the left side is suppressed effectively by 8.63 dB (=11.94−3.31), but the main beam gain is decreased slightly by 0.24 dB (=20.18−19.94). In addition, the gain difference between the main beam and the grating lobe increases from 8.24 dB (=20.18−11.94) to 16.63 dB (=19.94−3.31). Consequently, the grating lobe gain is suppressed or eliminated effectively by using the phase-control antenna module 1 of the present disclosure.

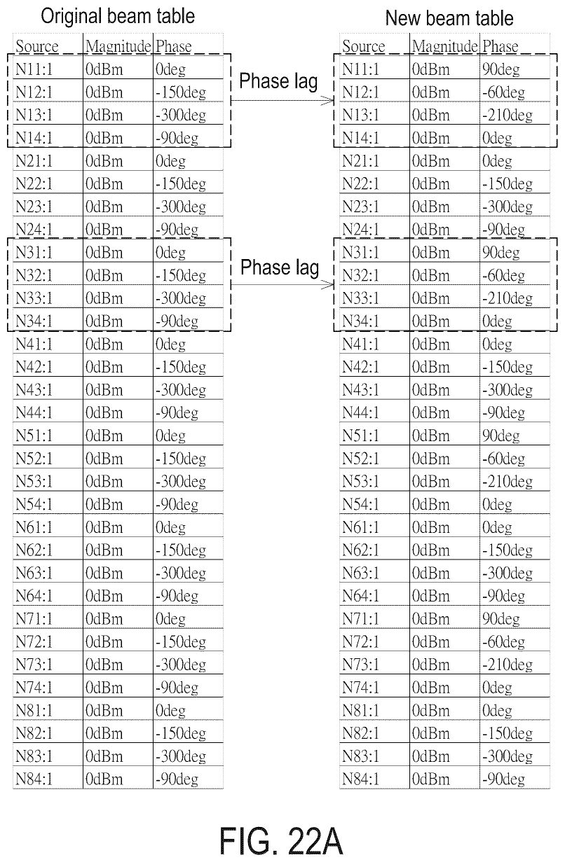

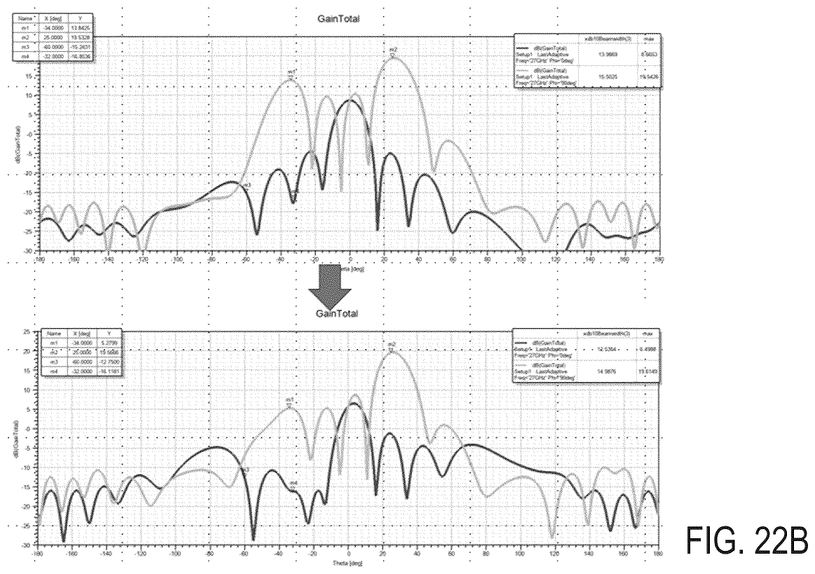

Please refer to FIGS. 18A and 18B. Similarly, the array antenna uses the power distributor to connect with the two sub-antennas in the Azimuth direction and performs beam steering at +25° in the Azimuth direction (θ-y) (i.e., the linear phase-shift unit (ψ-y) is) 150°. By performing phase compensation according to the beam steering control table shown in FIG. 21A, the phase-shift value (ψ-y) of the odd-numbered sub-antenna rows (columns) is added by 90°, and the phase-shift value (ψ-y) of the even-numbered sub-antenna rows (columns) maintains unchanged. As shown in FIG. 22B, the grating lobe gain on the left side is suppressed effectively by 8.63 dB (=11.94−3.31), but the main beam gain is increased by 0.02 dB (=19.56−19.53). The gain difference between the main beam and the grating lobe increases from 5.69 dB (=19.53−13.84) to 14.29 dB (=19.56−5.27)). Consequently, the grating lobe gain is suppressed or eliminated effectively by using the phase-control antenna module 1 of the present disclosure. In addition, the steering range in the Az direction (θ-y) can be extended from ±20° to ±25°.

According to the aforementioned embodiments, the phase-control array antenna module 1 of the present disclosure mainly utilizes the delaying between the two adjacent sub-antenna rows (columns) by one quarter wavelength and controls the phase compensation of the two adjacent sub-antenna rows (columns) to suppress and eliminate the grating lobes when the main beam is steered at a large steering angle. The aforementioned array antennas, each of which is formed by a single antenna, can achieve the effects of suppressing grating lobe at the maximum steering angle (θ) (e.g., the linear phase-shift unit (ψ) is) 180°, and the gain difference between the main beam and the grating lobe reaches more than 10 dB.

It should be emphasized that, as known from the aforementioned embodiments, the steering angle (θ) of the phase-control array antenna module 1 of the present disclosure for performing grating lobe gain suppression is used at a large steering angle (i.e., at a large steering angle (θ) interval). The aforementioned large angle is defined as the absolute value of the linear phase-shift unit being greater than 90° (ψ) (the maximum value is ±180°. If the absolute value of the linear phase-shift unit is less than (inclusive of) 90°, it belongs to the inner boundary scanning angle, and the suppression of the grating lobe gain is not executed.

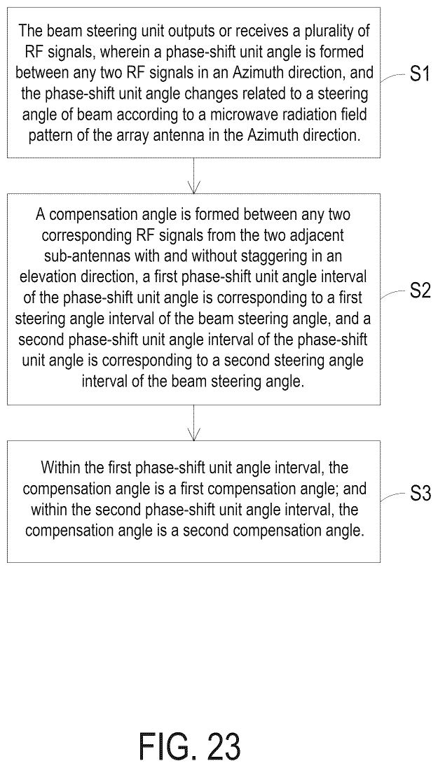

FIG. 23 is a flowchart illustrating the control method of the phase-control array antenna module of the present disclosure. As shown in FIG. 23, the phase-shift control method of the phase-control array antenna module 1 of the present disclosure includes the following steps. First, in step S1, the beam steering unit outputs or receives a plurality of RF signals. A phase-shift unit angle is formed between any two RF signals in an Azimuth direction. The phase-shift unit angle changes related to a steering angle of beam according to a microwave radiation field pattern of the array antenna in the Azimuth direction. Then, in the step S2, a compensation angle is formed and defined between any two corresponding RF signals from two adjacent sub-antennas with and without staggering in an EL direction. The first phase-shift unit angle interval of the phase-shift unit angle is corresponding to the first steering angle interval of the steering angle, and the second phase-shift unit angle interval of the phase-shift unit angle is corresponding to the second steering angle interval of the steering angle. Finally, in step S3, within the first phase-shift unit angle interval, the compensation angle is a first compensation angle or substantially zero degree; and within the second phase-shift unit angle interval, the compensation angle is a second compensation angle for example a specific angle interval that excludes zero degree. The other detailed processes of the phase-shift control method of the phase-control array antenna module 1 of the present disclosure has been described in the above embodiments, and will not be repeatedly described hereinafter.

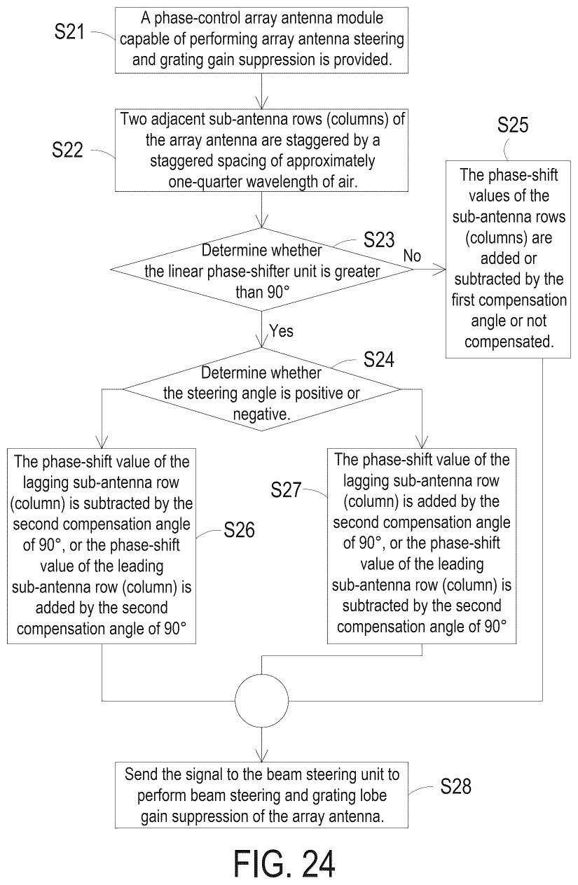

FIG. 24 is a flowchart illustrating the design of the phase-control array antenna module of the present disclosure for performing phase-shift compensation between two adjacent sub-antenna rows (columns). First, in step S21, a phase-control array antenna module capable of performing array antenna steering and grating lobe gain suppression is provided. Then, in step S22, two adjacent sub-antenna rows (columns) of the array antenna are staggered by a staggered spacing of approximately one-quarter wavelength of air. Thereafter, in step S23, determine whether the linear phase-shift unit is greater than 90°. If the determination result of the step S23 is “yes”, step S24 is executed, and if the determination result of step S23 is “no”, step S25 is executed. In step S24, determine whether the steering angle is positive or negative. If the determination result of the step S24 is “positive”, step S26 is executed, and if the determination result of step S24 is “negative”, step S27 is executed. In step S26, the phase-shift value of the lagging sub-antenna row (column) is subtracted by the second compensation value of 90°, or the phase-shift value of the leading sub-antenna row (column) is added by the second compensation value of 90°. In step S27, the phase-shift value of the lagging sub-antenna row (column) is added by the second compensation value of 90°, or the phase-shift value of the leading sub-antenna row (column) is subtracted by the second compensation value of 90°. In step S25, the phase-shift values of each sub-antenna row (column) are added or subtracted by the first compensation value or not compensated.

After the step S25, the step S26 and the step S27, step S28 is executed for sending the signal to the beam steering unit to perform wave beam steering and grating lobe gain suppression of the array antenna.

The efficacy and advantages of the phase-control array antenna module 1 of the present disclosure include follows:
(1) The phase compensation method of the phase-control array antenna module 1 of the present disclosure can be used in communication or radar systems to effectively expand the steering angle of the antenna and expand the dynamic range for receiving and transmitting signal.
(2) Comparing with the traditional grating lobe gain suppression methods, the phase-control array antenna module 1 of the present disclosure has simple array antenna arrangement and doesn't increase the correction difficulties of subsequent beam steering control.
(3) The phase compensation method of the phase-control array antenna module of the present disclosure can increase the overall steering angle by more than about 30° in both the azimuth direction and the elevation direction, which is much greater than the steering angles of current array antennas.
(4) In some embodiments, the phase-control array antenna module of the present disclosure is designed based on power considerations. The sub-antennas 21 of the array antenna 2 are connected in pairs. For a traditional 8×8 array antenna, the steering angle range of the sub-antennas in the direction of two-by-two connection is limited within +20° (exclusive). If the phase compensation method of the phase-control array antenna module of the present disclosure is performed, the steering angle range can be expanded to more than +25°, for example the steering angle is increased by more than 10°.

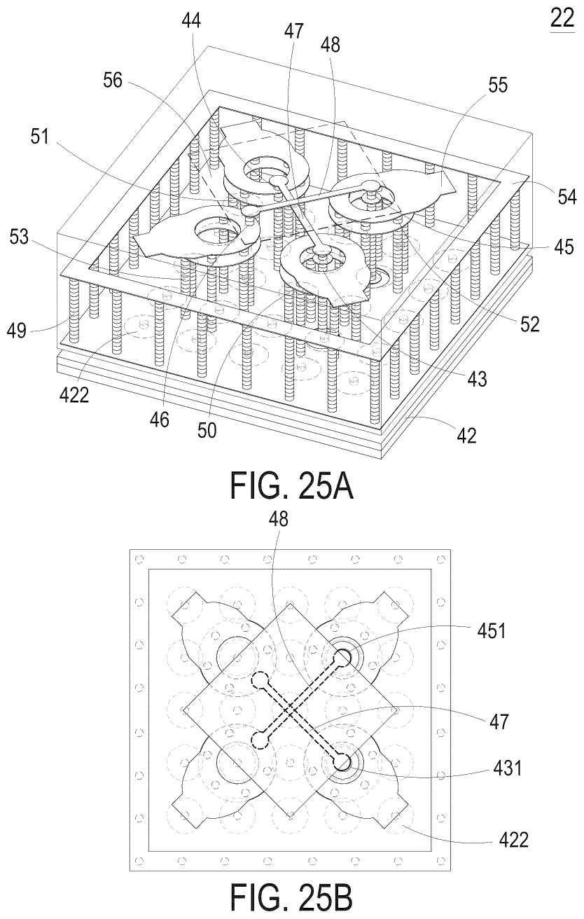

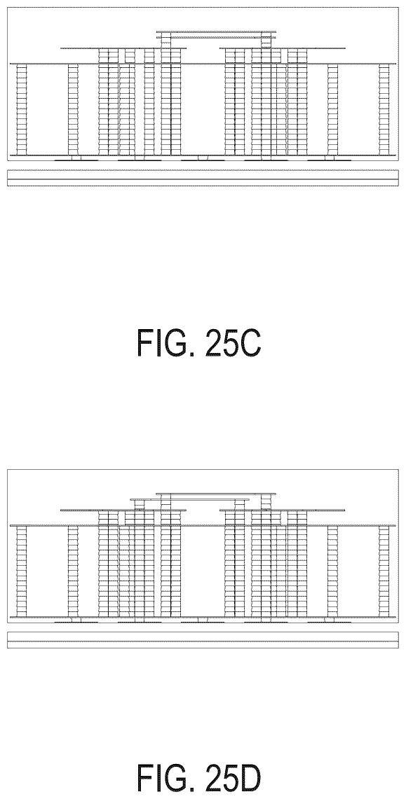

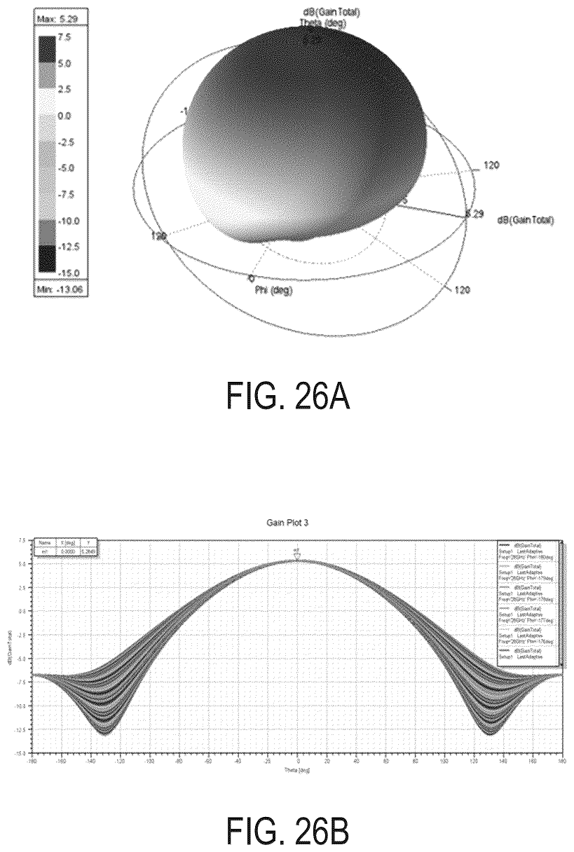

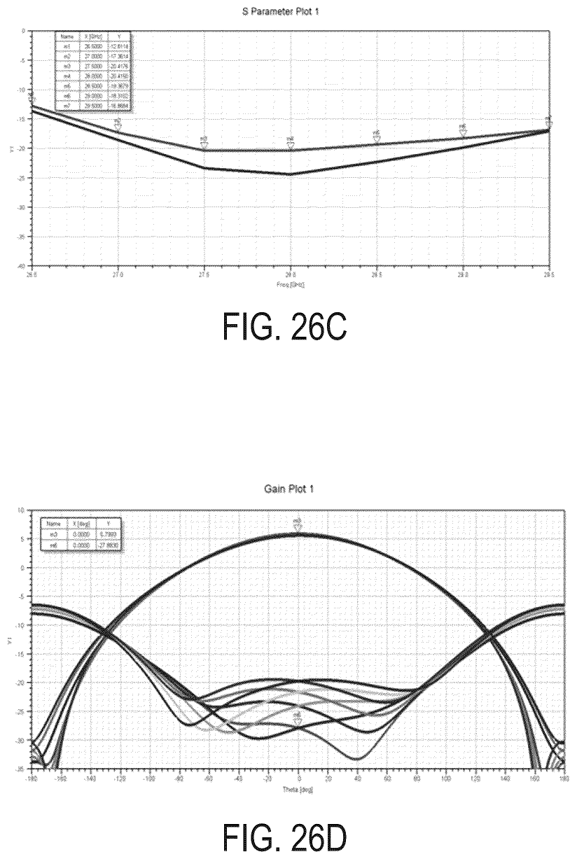

The phase-control array antenna module of the present disclosure is applicable to various array antenna applications. FIG. 25A is a three-dimensional diagram illustrating an exemplary array antenna of the phase-control array antenna module of the present disclosure. FIGS. 25B, 25C and 25D are top, front and side perspective views illustrating the array antenna of FIG. 25, respectively. FIGS. 26A and 26B show three-dimensional radiation field pattern of the array antenna and two-dimensional radiation field pattern corresponding to each Phi angle shown in FIG. 25A. FIG. 26C shows the reflection coefficient of the array antenna of FIG. 25A. FIG. 26D is a schematic perspective view illustrating the cross-polarization isolation of the dual-polarization array antenna shown in FIG. 25A. Phi is 0° in the elevation (EL) direction, and Phi is 90° in the azimuth (Az) direction. As shown in FIGS. 26A, 26C, and 26D, the antenna unit's reflection coefficient, also known as the scattering parameter S11, provides a substantially 3 GHz bandwidth, from 26.5 GHz to 29.5 GHz. Furthermore, the dual-polarization antenna unit exhibits cross-polarization isolation exceeding 25 dB, which provides excellent array antenna performance.

Please refer to FIGS. 25A, 25B, 25C, and 25D. The array antenna 2 includes a plurality of antenna units 22. Each antenna unit 22 includes a main body 41, a circuit board 42, a first radiating element 43, a second radiating element 44, a third radiating element 45, a fourth radiating element 46, a first connecting portion 47, a second connecting portion 48, a plurality of grounding posts 49, a plurality of first conductive posts 50, a plurality of second conductive posts 51, a plurality of third conductive posts 52, a plurality of fourth conductive posts 53, a grounding ring 54, a plurality of first impedance matching elements 55, and a second impedance matching element 56. The main body 41 is made of an insulating material. The circuit board 42 is disposed on a bottom surface of the main body 41 and includes a plurality of contact pads 422 such as metal pads or terminals. Preferably but not exclusively, the plurality of contact pads 422 are arranged in an array.

Each of the first radiating element 43, the second radiating element 44, the third radiating element 45 and the fourth radiating element 46 has a first end and a second end. The first end of each of the first radiating element 43, the second radiating element 44, the third radiating element 45 and the fourth radiating element 46 is electrically connected to the circuit board 42. The first connecting portion 47 is connected to the second end of the first radiating element 43 and the second end of the second radiating element 44. Consequently, the first radiating element 43, the second radiating element 44 and the first connecting portion 47 form a first signal transmission path and are configured as a first polarization part. The second connecting portion 48 is connected to the second end of the third radiating element 45 and the second end of the fourth radiating element 46. Consequently, the third radiating element 45, the fourth radiating element 46 and the second connecting portion 48 form a second signal transmission path and are configured as a second polarization part. In an embodiment, the first radiating element 43 has a first feeding end 431 disposed adjacent to the second end of the first radiating element 43. The third radiating element 45 has a second feeding end 451 disposed adjacent to the second end of the third radiating element 45. In an embodiment, the first radiating element 43, the second radiating element 44, the third radiating element 45 and the fourth radiating element 46 are arranged to form a rectangle. Preferably but not exclusively, the first radiating element 43 and the second radiating element 44 are located at opposite ends of a first diagonal line, and the third radiating element 45 and the fourth radiating element 46 are located at opposite ends of a second diagonal line.

The plurality of first conductive posts 50, the plurality of second conductive posts 51, the plurality of third conductive posts 52 and the plurality of fourth conductive posts 53 are respectively disposed adjacent to the corresponding one of the first radiating element 43, the second radiating element 44, the third radiating element 45 and the fourth radiating element 46. Each of the plurality of first conductive posts 50, the plurality of second conductive posts 51, the plurality of third conductive posts 52 and the plurality of fourth conductive posts 53 has a first end and a second end. The first end of each of the plurality of first conductive posts 50, the plurality of second conductive posts 51, the plurality of third conductive posts 52 and the plurality of fourth conductive posts 53 is connected to the circuit board 42. Each of the first radiating element 43, the second radiating element 44, the third radiating element 45 and the fourth radiating element 46 has a first length. Each of the plurality of first conductive posts 50, the plurality of second conductive posts 51, the plurality of third conductive posts 52 and the plurality of fourth conductive posts 53 has a second length. In one embodiment, preferably but not exclusively, the first length is greater than the second length.

Each of the plurality of grounding posts 49 has a first end and a second end. Each first end of the plurality of grounding posts 49 is connected to a corresponding one of the plurality of contact pads 422 on the circuit board 42 (e.g., metal pads or terminals) for grounding. The grounding ring 54 is disposed in the accommodating space 41a and connected to the second ends of the plurality of grounding posts 49. Each of the plurality of grounding posts 49 has a third length. In one embodiment, preferably but not exclusively, the third length is less than the second length, and the second length is less than the first length.

The plurality of first impedance matching elements 55 are disposed within the main body 41 and are respectively connected to corresponding radiating elements among the first radiating element 43, the second radiating element 44, the third radiating element 45 and the fourth radiating element 46, and are respectively adjacent to the second ends of the first radiating element 43, the second radiating element 44, the third radiating element 45 and the fourth radiating element 46. In some embodiments, the plurality of first impedance matching elements 55 are respectively connected to the second ends of the corresponding conductive posts of the plurality of first conductive posts 50, the plurality of second conductive posts 51, the plurality of third conductive posts 52, and the plurality of fourth conductive posts 53. In one embodiment, preferably but not exclusively, the first impedance matching elements 55 are circular or elliptical metal sheets. The second impedance matching element 56 is disposed within the main body 41 and at least partially covers the aforementioned first polarization part and the second polarization part. The second impedance matching element 56 is located above the plurality of first impedance matching elements 55 and configured to couple with the first polarization part and the second polarization part for achieving impedance matching. In an embodiment, preferably but not exclusively, the second impedance matching element 56 is a square metal sheet. The antenna unit 22 of this embodiment is a double-dipole antenna unit. The structure of the antenna unit 22 can isolate the signals transmitted and received through the first signal transmission path and the second signal transmission path from each other without interference, and provide a wider bandwidth.

It should be emphasized that the structure of the antenna unit 22 of the array antenna 2 of the present disclosure is not limited to the aforementioned embodiments, and can be adjusted according to actual application requirements.

In an embodiment, according to the application of low-orbit satellite communication, the steering angle resolution is limited to within 2°. From the beam steering phase-shift formula, it is known that when the linear phase-shift unit is 5.625°, the error of the steering angle is 1.8°. Therefore, the steering angle resolution fits the limit of less than 2°, and the range of the “inner boundary scanning angle” is actually from 85 degrees to 95 degrees. In addition, since the steering angle resolution is limited to be less than 2°, the phase-shift value of the “second compensation angle” is actually between 87.5 degrees to 92.5 degrees.

Please refer to FIG. 8 again. The even-numbered sub-antenna rows (columns) of the array antenna 2 are staggered relative to the odd-numbered sub-antenna rows (columns) by a staggered spacing of approximately one-quarter wavelength of air (i.e., λ₀/4). The corresponding phase of λ₀/4 is 90°. If the error of the staggered spacing (λ₀/4) is taken into consideration, it can be adjusted by the following factors.

The tolerable deviation of the phase is estimated to be ±5° for reference (originally estimated to be) 5.625°, which is converted to the length deviation of ±5.56%. If the operating frequency f_{c} is 28 GHz, according to the formula f_{c}×λ₀=C (speed of light), the corresponding wavelength Ao is approximately 10.714 mm, and λ₀/4 is approximately 2.679 mm. Since the length deviation of the λ₀/4 is in the range of ±5.56%, the length of the staggered spacing is in the range between 2.53 mm and 2.83 mm. As the operating frequency f_{c} increases from 27 GHz to 30 GHz, the length deviation of the λ/4 (i.e., +5.56%) also changes. The relations between the operating frequencies and the length range of λ₀/4 are depicted in Table 2 below. It is obvious that when the operating frequency is in the range between 27 GHz and 30 GHz, the length of λ₀/4 is in the range between 2.36 mm and 2.93 mm.

TABLE 2

| | Operating frequency f_{c} | | | |
|---|---|---|---|---|
| | 27 GHz | 28 GHz | 29 GHz | 30 GHz |
| Length range | 2.62 mm- | 2.53 m- | 2.44 mm- | 2.36 mm- |
| of λ₀/4 | 2.93 mm | 2.83 mm | 2.73 mm | 2.64 mm |

In addition, the traditional antenna resonator uses half the wavelength as the resonant frequency, that is, the main dimension of the antenna is half the wavelength (i.e., λ0/2). Various antennas have their own bandwidths. In 5G FR2 antenna applications, the commonly used bandwidth range of the antenna is around 2 GHz. The aforementioned resonant frequency is, in general, located at the center of the 2 GHz (i.e., half the bandwidth). However, due to the variations of the manufacturing process, the operation frequency may be deviated. In order to cover the operation frequency and compensate the variations of the manufacturing process, the deviation tolerance range can be set by adding or subtracting one-quarter bandwidth when the operation frequency is half the bandwidth. For example, if the operation frequency is set at 28 GHz and the bandwidth is 2 GHz (i.e., the operation frequency is in the range between 27 GHz and 29 GHz), the operating frequency at half the bandwidth added or subtracted one quarter bandwidth is in the range between 27.5 GHZ and 28.5 GHZ, and the corresponding wavelength is λ0=C/f, in mm. Accordingly, λ01=3×1011/27.5×109≈10.91 (mm), and λ01/2=5.45 (mm). λ02−3×1011/28.5×109≈10.53 (mm), and λ02/2−5.26 (mm). The length of the side is in the range between 5.26 mm and 5.45 mm. When the operating frequency is set at 27 GHz, the length of side is in the range between 5.45 mm and −5.66 mm.

Moreover, the feeding ends of the two antenna units are connected in parallel. The two antennas are served as one antenna unit block, and the size and shape of each antenna unit block are the same as that of a single antenna. Please refer to FIGS. 14A and 14B. If the array antenna uses the staggered arrangement as shown in FIG. 14A, the feeding ends of the two antenna units are connected in parallel. The connection structure and method are depicted in FIGS. 18A and 18B. With respect to the size of the antenna unit block, the long side of the antenna unit block is in the X direction. If the operation frequency is 27 GHz, the length of the long side is in the range between 10.9 mm to 11.32 mm, and the length of the short side is in the range between 5.45 mm and 5.66 mm. If the operation frequency is 28 GHz, the length of the long side is in the range between 10.52 mm and 10.9 mm, and the length of the short side is in the range between 5.26 mm and 5.45 mm. If the array antenna uses the staggered arrangement as shown in FIG. 14B, that is, the antenna units of the array antenna of FIGS. 18A and 18B are connected by flipping 90 degrees, the feeding ends of the two antenna units are connected in parallel. With respective to the size of the antenna unit block, the short side is in the X direction. If the operation frequency is 27 GHz, the length of the long side is in the range between 10.9 mm and 11.32 mm, and the length of the short side is in the range between 5.45 mm and 5.66 mm. If the operation frequency is 28 GHz, the length of the long side is in the range between 10.52 mm and 10.9 mm, and the length of the short side is in the range between 5.26 mm and 5.45 mm.

It should be emphasized that the aforementioned dimensions and tolerances are not limited to the aforementioned embodiments, and can be adjusted according to actual application requirements. In addition, the above-mentioned azimuth direction can be replaced by the elevation direction, and vice versa. The above-mentioned row arrangement can be replaced by the column arrangement, and vice versa. Consequently, the technology and functions are also realized.

In summary, the present disclosure provides a phase-control array antenna module and a phase-shift control method thereof, which can suppress or eliminate the grating lobe gain of the array antenna, expend the maximum angle range of beam steering, and expend the dynamic range at large steering angles. When the beam of the array antenna is steered to its maximum steering angle, the performance of the array antenna is affected by the grating lobe gain (i.e., the side beam) and the attenuation of the main beam. The structure and phase-shift control method of the phase-control array antenna module of the present disclosure can suppress the grating lobe gain, ensure that the beam of the array antenna maintains stability, efficiency, and high performance when steered at large steering angles, and expend the maximum angle range of beam steering and the dynamic range at large steering angles.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A phase-control array antenna module, comprising:
an array antenna, comprising a plurality of sub-antennas arranged in an array to configure the array antenna, wherein each of the plurality of sub-antennas comprises at least one antenna unit, and any two adjacent sub-antenna rows or columns of the plurality of sub-antennas are staggered in a first direction; and
a beam steering unit, configured to output or receive a plurality of RF signals via corresponding sub-antenna among the plurality of sub-antennas of the array antenna;
wherein a phase-shift unit angle is formed between any two of the RF signals in an azimuth direction, and the phase-shift unit angle changes related to a steering angle of a beam according to a microwave radiation field pattern of the array antenna in the azimuth direction,
wherein a compensation angle is formed between the two RF signals from the two adjacent sub-antennas with and without staggering in an elevation direction,
wherein a first phase-shift unit angle interval of the phase-shift unit angle is corresponding to a first steering angle interval of the steering angle, and a second phase-shift unit angle interval of the phase-shift unit angle is corresponding to a second steering angle interval of the steering angle, and
wherein within the first phase-shift unit angle interval, the compensation angle is a first compensation angle, and within the second phase-shift unit angle interval, the compensation angle is a second compensation angle.

2. The phase-control array antenna module according to claim 1, wherein the plurality of sub-antennas are configured to form a plurality of sub-antenna rows or columns, wherein any two the adjacent sub-antenna rows or columns are staggered in the first direction, wherein a staggered spacing is formed between the two adjacent sub-antenna rows or columns and the staggered spacing is one-quarter wavelength of air.

3. The phase-control array antenna module according to claim 2, wherein the length of the staggered spacing is in the range between 2.36 mm and 2.93 mm, a spacing is formed between the antenna units of any two adjacent sub-antenna rows or columns, and the length of the spacing is in the range between 5.26 mm and 5.66 mm.

4. The phase-control array antenna module according to claim 2, wherein outer ends of the antenna units at the ends of the odd-number rows or columns among the plurality of sub-antenna rows or columns are aligned with each other and have the staggered spacing with a reference line, wherein outer ends of the antenna units at the ends of the even-number rows or columns among the plurality of sub-antenna rows or columns are aligned with each other and aligned with the reference line; or wherein outer ends of the antenna units at the ends of the odd-number rows or columns among the plurality of sub-antenna rows or columns are aligned with each other and aligned with the reference line, and outer ends of the antenna units at the ends of the even-number rows or columns among the plurality of sub-antenna rows or columns are aligned with each other and have the staggered spacing with the reference line.

5. The phase-control array antenna module according to claim 2, wherein the two antenna units in the sub-antenna column are arranged in a second direction, each of the two antenna units has a feeding end, and the feeding ends of the two antenna units are connected in parallel, wherein the number of the sub-antenna columns in the first direction is greater than the number of the sub-antenna columns in the second direction.

6. The phase-control array antenna module according to claim 2, wherein the number of the sub-antenna columns in the first direction is equal to the number of the sub-antenna columns in the second direction, or the number of the sub-antenna columns in the first direction is less than the number of the sub-antenna columns in the second direction.

7. The phase-control array antenna module according to claim 6, wherein the first direction and the second direction are orthogonal to each other on one surface of the array antenna.

8. The phase-control array antenna module according to claim 1, wherein the first compensation angle is zero degree, and the second compensation angle is a specific angle interval excluding zero degree.

9. The phase-control array antenna module according to claim 1, wherein the first steering angle interval comprises zero degree, the second steering angle interval comprises a specific angle interval excluding zero degree, and the absolute value of the second steering angle interval is greater than the absolute value of the first steering angle interval.

10. The phase-control array antenna module according to claim 1, wherein the absolute value of the second phase-shift unit angle interval is greater than the absolute value of the first phase-shift unit angle interval.

11. The phase-control array antenna module according to claim 1, wherein the second compensation angle is in the range between 85 degrees and 95 degrees, or in the range between −85 degrees and −95 degrees.

12. The phase-control array antenna module according to claim 1, wherein the second compensation angle is ±90°.

13. The phase-control array antenna module according to claim 1, wherein the first phase-shift unit angle interval is in the range between −95 degrees and +95 degrees, or in the range between −90 degrees and +90 degrees, wherein the second phase-shift unit angle interval is in the range between −180 degrees and +180 degrees, or in the range between −90 degrees and +90 degrees.

14. The phase-control array antenna module according to claim 1, wherein each of the antenna units comprises:
a main body;
a circuit board, disposed on a bottom surface of the main body and comprising a plurality of contact pads, wherein the plurality of contact pads are arranged in an array;
a first radiating element, a second radiating element, a third radiating element and a fourth radiating element, wherein each of the first radiating element, the second radiating element, the third radiating element and the fourth radiating element has a first end and a second end, the first ends of the first radiating element, the second radiating element, the third radiating element and the fourth radiating element are connected to the circuit board;
a first connecting portion, connected to the second end of the first radiating element and the second end of the second radiating element, wherein the first radiating element, the second radiating element and the first connecting portion form a first signal transmission path and are configured as a first polarization part;
a second connecting portion, connected to the second end of the third radiating element and the second end of the fourth radiating element, wherein the third radiating element, the fourth radiating element and the second connecting portion form a second signal transmission path and are configured as a second polarization part;
a first feeding end, disposed adjacent to the second end of the first radiating element;
a second feeding end, disposed adjacent to the second end of the third radiating element;
a plurality of first impedance matching elements, disposed within the main body and connected to the corresponding radiating elements among the first radiating element, the second radiating element, the third radiating element and the fourth radiating element, respectively; and
a plurality of first conductive posts, a plurality of second conductive posts, a plurality of third conductive posts and a plurality of fourth conductive posts, disposed adjacent to the corresponding one of the first radiating element, the second radiating element, the third radiating element and the fourth radiating element, respectively, wherein each of the plurality of first conductive posts, the plurality of second conductive posts, the plurality of third conductive posts and the plurality of fourth conductive posts is connected to the circuit board and the corresponding first impedance matching element among the plurality of first impedance matching elements;
a grounding ring, disposed in the main body;
a plurality of grounding posts, connected to the corresponding contact pads of the plurality of contact pads on the circuit board and the grounding ring; and
a second impedance matching element, disposed within the main body and at least partially covering the first polarization part and the second polarization part.

15. The phase-control array antenna module according to claim 14, wherein each of the first radiating element, the second radiating element, the third radiating element and the fourth radiating element has a first length, wherein each of the plurality of first conductive posts, the plurality of second conductive posts, the plurality of third conductive posts and the plurality of fourth conductive posts has a second length, wherein each of the plurality of grounding posts has a third length, wherein the third length is less than the second length, and the second length is less that the first length.

16. A phase-shift control method of a phase-control array antenna module, wherein the phase-control array antenna module comprises an array antenna and a beam steering unit, the array antenna comprises a plurality of sub-antennas arranged in an array, each of the plurality of sub-antennas comprises at least one antenna unit, any two adjacent sub-antenna rows or columns of the plurality of sub-antennas are staggered in the first direction, the beam steering unit is configured to output or receive a plurality of RF signals via corresponding sub-antennas among the plurality of sub-antennas, wherein the phase-shift control method comprises:
(S1) the beam steering unit outputting or receiving a plurality of RF signals, wherein a phase-shift unit angle is formed between any two of the RF signals in an Azimuth direction, and the phase-shift unit angle changes related to a steering angle of a beam according to a microwave radiation field pattern of the array antenna in the Azimuth direction;
(S2) a compensation angle being formed between any two of the RF signals from two adjacent sub-antennas with and without staggering in an elevation direction, a first phase-shift unit angle interval of the phase-shift unit angle being corresponding to a first steering angle interval of the steering angle, and a second phase-shift unit angle interval of the phase-shift unit angle being corresponding to a second steering angle interval of the steering angle; and
(S3) within the first phase-shift unit angle interval, the compensation angle being a first compensation angle; and within the second phase-shift unit angle interval, the compensation angle being a second compensation angle.

17. The phase-shift control method according to claim 16, wherein the plurality of sub-antennas are configured to form a plurality of sub-antenna rows or columns, wherein any two the adjacent sub-antenna rows or columns are staggered in the first direction, wherein a staggered spacing is formed between the two adjacent sub-antenna rows or columns, and the staggered spacing is one-quarter wavelength of air.

18. The phase-shift control method according to claim 16, wherein the first compensation angle is zero degree, and the second compensation angle is a specific angle interval excluding zero degree.

19. The phase-shift control method according to claim 16, wherein the first steering angle interval comprises zero degree, the second steering angle interval comprises a specific angle interval excluding zero degree, and the absolute value of the second steering angle interval is greater than the absolute value of the first steering angle interval.

20. The phase-shift control method according to claim 16, wherein the absolute value of the second phase-shift unit angle interval is greater than the absolute value of the first phase-shift unit angle interval.

21. The phase-shift control method according to claim 16, wherein the second compensation angle is in the range between 85 degrees and 95 degrees, or in the range between −85 degrees and −95 degrees.

22. The phase-shift control method according to claim 16, wherein the second compensation angle is ±90°.

23. The phase-shift control method according to claim 16, wherein the first phase-shift unit angle interval is in the range between −95 degrees and +95 degrees, or in the range between −90 degrees and +90 degrees, wherein the second phase-shift unit angle interval is in the range between −180 degrees and +180 degrees, or in the range between −90 degrees and +90 degrees.
